(19) United States
(12) Patent Application Publication
(10) Pub. No.: US 2017/0116546 A1
(43) Pub. Date: Apr. 27, 2017

(54) Systems and Methods for Matching Providers and Consumers of Personal Care Services

(71) Applicant: Alicia Machel Alonzo-Reynaud, New Orleans, LA (US)

(72) Inventor: Alicia Machel Alonzo-Reynaud, New Orleans, LA (US)

(21) Appl. No.: 14/919,163

(22) Filed: Oct. 21, 2015

(51) Int. Cl. G06Q 10/02; G06Q 20/10; G06Q 30/06

(52) U.S. Cl. CPC G06Q 10/02; G06Q 30/0617; G06Q 20/102

(57) ABSTRACT

Location-based systems and methods for matching providers of personal care services with consumers seeking those services are disclosed. A consumer may search for services by viewing providers who are associated with the consumer's location, reviewing provider profiles for those providers, and selecting a provider who offers the services the consumer is seeking. Consumers may also search by selecting a service and viewing providers who provide the selected service. Personal care services may include any type of service that cares for, nurtures, improves, or heals the body and/or mind of a person, such as hair care, face care, and yoga sessions. Methods for identifying consumers and providers on a map and determining their location and proximity relative to each other may include various location and mapping technologies, such as Apple GPS Location Services and Android GPS Location Services.

### FIELD OF INVENTION

The present invention relates generally to systems and methods that match service providers with consumers. More specifically, the present invention relates to location-based systems and methods that match providers of personal care services with consumers seeking those services.

### BACKGROUND

In recent years, websites and applications for matching providers and consumers of services have becoming increasingly popular. A number of websites and applications have been developed to enable consumers to find service providers by entering search criteria, such as geographic location and product or service category. Examples of these websites and applications include Yelp, Yahoo! Local, Angie's List, Yellow Pages (YP.com), TripAdvisor, Superpages, and Insider Pages. These websites and applications generally incorporate reviews provided by a large online community of users and allow consumers to search for providers based on other user's ratings of those providers.

Consumers seeking personal care services, such as hair care, nail care, and massage, currently may use the general purpose crowd-sourced review websites described above or may conduct searches using map applications, such as Google Maps or Bing Maps. However, both types of applications (i.e. crowd-sourced review applications and map applications) suffer from a number of drawbacks. First, these applications do not allow a consumer to easily summon a provider to the consumer's location; generally providers are associated with a physical location and consumers are expected to travel to that location. Second, these applications do not offer consistent and predictable fees for products and services. Providers may charge whatever fees they wish for services, and the application merely reports those fees, and in some cases, may not provide a fee or fee range at all. Third, these applications generally do not allow customers to pay for services via the application itself. Fourth, these applications do not allow providers to purchase professional insurance and add-on services. It would therefore be desirable to provide methods and systems for matching providers and consumers of personal care services that overcome these drawbacks.

### SUMMARY OF THE INVENTION

Location-based methods and systems for matching providers and consumers of personal care services are disclosed. In one embodiment, a computer-implemented method for matching providers and consumers of personal care services comprises receiving from a consumer a location associated with the consumer and transmitting to the consumer an identification of a personal care service provider located within a geographical area associated with the consumer's location. The method also comprises transmitting an identification of a personal care service offered by the personal care service provider and receiving from the consumer a request for the personal care service offered by the personal care service provider. The method also comprises generating an appointment for the consumer and the personal care service provider based on the consumer's request and transmitting appointment-related information to the consumer and personal care service provider. The method may also comprise receiving a payment for the personal care service requested by the consumer where the payment is based on a pre-determined fee associated with a category of personal care services.

In another embodiment, a computer-implemented method for matching providers and consumers of personal care services comprises receiving from a consumer a location associated with the consumer and an identification of a personal care service. The method also comprises transmitting to the consumer an identification of a personal care service provider who is located within a geographical area associated with the consumer's location and who offers the personal care service identified by the consumer and receiving from the consumer a request for the personal care service provider to perform the personal care service identified by the consumer. The method further comprises generating an appointment for the consumer and the personal care service provider based on the consumer's request and transmitting appointment-related information to the consumer and the personal care service provider. The method may also comprise receiving a payment for the personal care service requested by the consumer where the payment is based on a pre-determined fee associated with a category of personal care services.

In another embodiment, a computer system for matching providers and consumers of personal care services comprises a processor and a computer-readable medium that includes computer program code for receiving from a consumer a location associated with the consumer and transmitting to the consumer an identification of a personal care service provider located within a geographical area associated with the consumer's location. The medium further includes code for transmitting an identification of a personal care service offered by the personal care service provider and receiving from the consumer a request for the personal care service offered by the personal care service provider. The medium also includes code for generating an appointment for the consumer and the personal care service provider based on the consumer's request and transmitting appointment-related information to the consumer and personal care service provider. The medium may also include code for receiving a payment for the personal care service requested by the consumer where the payment is based on a pre-determined fee associated with a category of personal care services.

In another embodiment, a computer system for matching providers and consumers of personal care services comprises a processor and a computer-readable medium that includes computer program code for receiving from a consumer a location associated with the consumer and receiving from the consumer an identification of a personal care service. The medium also includes code for transmitting to the consumer an identification of a personal care service provider who is located within a geographical area associated with the consumer's location and who offers the personal care service identified by the consumer and receiving from the consumer a request for the personal care service provider to perform the personal care service identified by the consumer. The medium further includes code for generating an appointment for the consumer and the personal care service provider based on the consumer's request and transmitting appointment-related information to the consumer and personal care service provider. The medium may also include code for receiving a payment for the personal care service requested by the consumer where the payment is based on a pre-determined fee associated with a category of personal care services.

These and other aspects of the invention may be more clearly understood by reference to the following detailed description of the invention and the appended claims.

### BRIEF DESCRIPTION OF THE DRAWINGS

The preferred embodiments of the present invention are illustrated by way of example and not limited to the following figures.

FIG. 1 illustrates a system for matching providers and consumers of personal care services in which embodiments of the present invention may be implemented.

FIG. 2 illustrates an exemplary implementation of a host server system.

FIG. 3 illustrates an exemplary user device.

FIG. 4A is a flow diagram illustrating a method for matching providers and consumers of personal care services according to one embodiment of the present disclosure.

FIG. 4B is a flow diagram illustrating a method for matching providers and consumers of personal care services according to another embodiment of the present disclosure.

FIG. 5A is a flow diagram illustrating various functions that may be provided to consumers as part of an application that matches providers and consumers of personal care services.

FIG. 5B is a continuation of FIG. 5A.

FIG. 5C is a flow diagram illustrating various functions that may be provided to providers as part of an application that matches providers and consumers of personal care services.

FIG. 6 illustrates an exemplary home screen.

FIG. 7 illustrates an exemplary sign-in screen.

FIG. 8 illustrates an exemplary registration screen.

FIG. 9 illustrates an exemplary privacy statement pop-up box.

FIG. 10 illustrates an exemplary consumer navigation screen.

FIG. 11 illustrates an exemplary provider search screen.

FIG. 12 illustrates an exemplary appointment screen.

FIG. 13 illustrates an exemplary appointment location selection popup.

FIG. 14 illustrates an exemplary consumer profile display screen.

FIG. 15 illustrates an exemplary service selection screen.

FIG. 16 illustrates an exemplary service selection screen.

FIG. 17 illustrates an exemplary service selection screen.

FIG. 18 illustrates an exemplary service selection screen.

FIG. 19 illustrates an exemplary provider selection screen.

FIG. 20 illustrates an exemplary provider portfolio screen.

FIG. 21 illustrates an exemplary consumer schedule screen.

FIG. 22 illustrates an exemplary consumer schedule detail screen.

FIG. 23 illustrates an exemplary rating screen that a consumer may use to rate a provider.

FIG. 24 illustrates an exemplary thank you screen.

FIG. 25 illustrates an exemplary order summary screen that displays information about the services a consumer has ordered.

FIG. 26 illustrates an exemplary payment confirmation popup screen.

FIG. 27 illustrates an exemplary appointment confirmation popup screen.

FIG. 28 illustrates an exemplary payment method selection screen.

FIG. 29 illustrates an exemplary payment information screen.

FIG. 30 illustrates an exemplary payment terms popup screen.

FIG. 31 illustrates an exemplary provider navigation screen.

FIG. 32 illustrates an exemplary provider schedule screen.

FIG. 33 illustrates an exemplary provider schedule screen that displays upcoming appointments.

FIG. 34 illustrates an exemplary provider schedule details screen.

FIG. 35 illustrates an exemplary appointment completion screen.

FIG. 36 illustrates an exemplary rating screen that a provider may use to rate a consumer.

FIG. 37 illustrates an exemplary provider availability screen that allows a provider to enter dates and times that the provider is available to perform services.

FIG. 38 illustrates an exemplary time selector popup screen.

FIG. 39 illustrates an exemplary provider profile display screen that allows a provider to view the provider's personal information, contact information, bio, and work samples.

FIG. 40 illustrates an exemplary provider profile edit screen that allows a provider to edit his or her profile information.

### DETAILED DESCRIPTION OF THE INVENTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Personal care services may include any type of service that cares for, nurtures, improves, or heals the body and/or mind of a person, including, without limitation, hair care, face care, nail care, hair removal, massage, anti-aging treatments, barber services, tanning treatments, psychotherapy, yoga, pilates, life coaching, medical treatments (doctor's house calls), meditation sessions, mindfulness training, and nutrition counseling. Hair care services may include, for example, coloring and highlights, cutting, chemical treatments (e.g. smoothing, perms, and anti-curl treatments), and styling. Face care may include, among other things, facials, eyebrow shaping, lip waxing, chin waxing, and makeup application. Nail care may include, for example, manicures and pedicures. Hair removal may include waxing and laser hair removal. Massage may include all types of massage, including Swedish, sports, deep tissue, and reflexology. Anti-aging treatments may include Botox treatments and fillers. Barber services may include classic barber shaves and beard and mustache trimming. Tanning may include spray-on tans and UV tanning Personal care services may also include services applied to the body of an animal (e.g. a pet may receive grooming services).

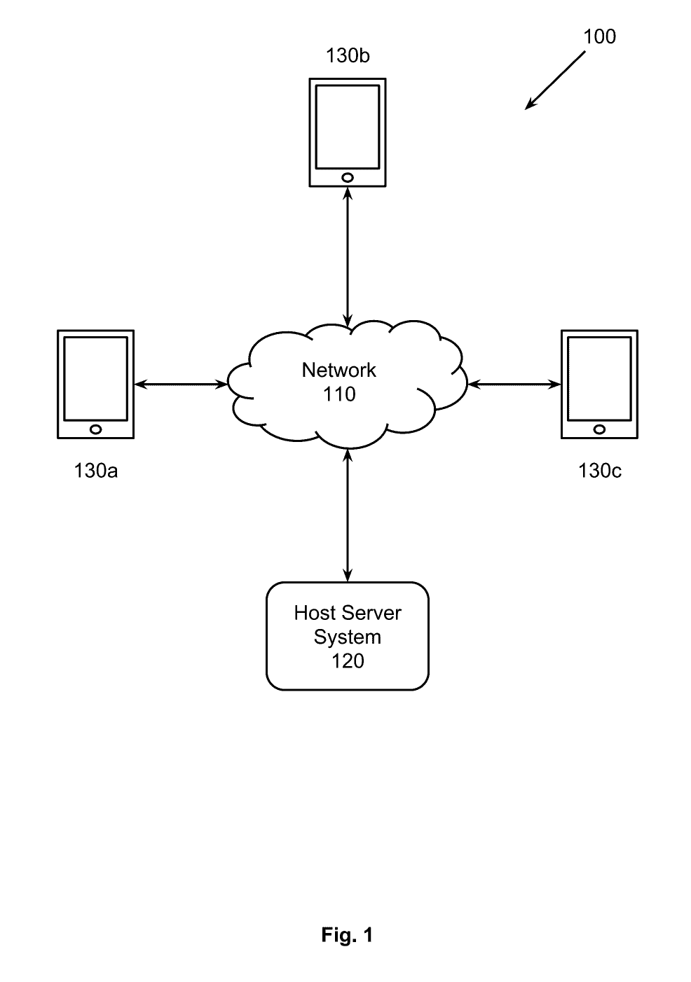

FIG. 1 illustrates a system for matching providers and consumers of personal care services in which embodiments of the present invention may be implemented. A provider-and-consumer matching system (“matching system”) 100 includes a host server system 120 in communication via a network 110 with a plurality of user devices 130. A user may be a provider or a consumer. The network may comprise any network (e.g., a telecommunications network in conjunction with the Internet) capable of supporting bidirectional communication between the host server system 120 and the plurality of user devices 130.

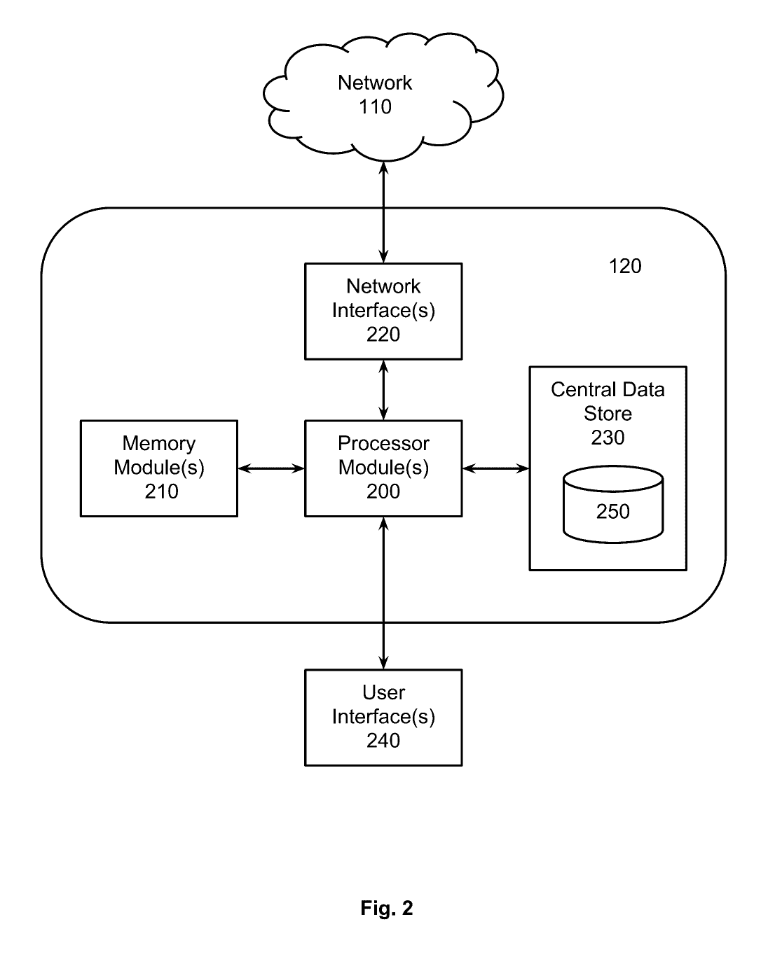

FIG. 2 illustrates an exemplary implementation of the host server system 120. The host server system 120 includes one or more processor modules 200 in communication with one or more memory modules 210. The memory modules 210 may include code executable by the processor modules 200 to implement the matching of providers and consumers described herein. The host server system 120 includes a central data store 230 containing information relating to users of the user devices 130. The exchange of information between the central data store 230 and the user devices 130 is facilitated by one or more network interfaces 220 in communication with user devices 130 on network 110. System operators may interact with the host server system 120 using user interfaces 240 or remotely via network interfaces 220. The central data store 230 may be implemented as one or more data stores or databases 250 spread across one or more servers.

As shown, at least one database 250 may be accessed by the processor modules 200. It will be appreciated that the database may be accessed by the server over a network or via another wired or wireless connection. The server may store desired or required information in the database and may access the same to retrieve the information.

A database 250 may be in communication with an object relational mapping (“ORM”) also known as an object relational model or object-relational database management system. It will be appreciated that the ORM may be accessed by processor modules 200 over the network 110 or via physical connection.

The ORM may be in communication with one or more of the following: a Universal Resource Indicator (URI) mapper and a Rest API generator. First, the URI mapper may map a URI into a pointer to an internal program, view, logic, or presentation of data within the system, based on one or more rules of a matching object specified in a collection of mapping objects. The matching object may be a regular expression. The URI mapper may be in communication with a web server.

The Rest API generator may be in communication with a web server as to send and/or receive data to/from user devices 130 communicating with the server using HTTP and/or HTTPS. The Rest API generator may prepare data stored in the database 250 for delivery to a client device or may prepare data received from a client device for storage in the database. The Rest API may be capable of translating between formats including, but not limited to JSON, XML, CSV, and the like. The Rest API may be capable of automatically generating URIs based upon data structures observed in the ORM for access by client devices.

A web server may be adapted to deliver web pages on request to users using the Hypertext Transfer Protocol (HTTP and/or HTTPS) or similar protocols. This allows for delivery of HTML documents and any additional content that may be included by a document, such as images, style sheets and scripts.

A user device 130 may employ a web browser or similar client application to engage in communication with a web server. For example, a client application may make a request for a specific resource using HTTP/HTTPS and the web server may respond with the content of that resource or an error message if unable to do so. The resource may be data or a file stored in a database 25. The web server can receive content from a user, possibly using HTTP/HTTPS.

In certain embodiments, a user may access the host server system 120 (i.e., an application running on the server) through a user device 130 connected to a network 110. A user device 130 may be any device capable of accessing the server such as by running a client application or other software, like a web browser or web-browser-like application. In one embodiment, a user device 130 may comprise, for example, an input/output device, a display, a processor, memory, and/or audio equipment such that the user may utilize the user device to create and/or edit documents using the word processor. Exemplary user devices include, but are not limited to, general purpose computers, laptops, cell phones, smart phones, personal digital assistants, televisions, tablets, and the like. Once an access device establishes a connection to the host server system 120, such as through the network 110, the user may log into the system to access a provider-and-consumer matching program.

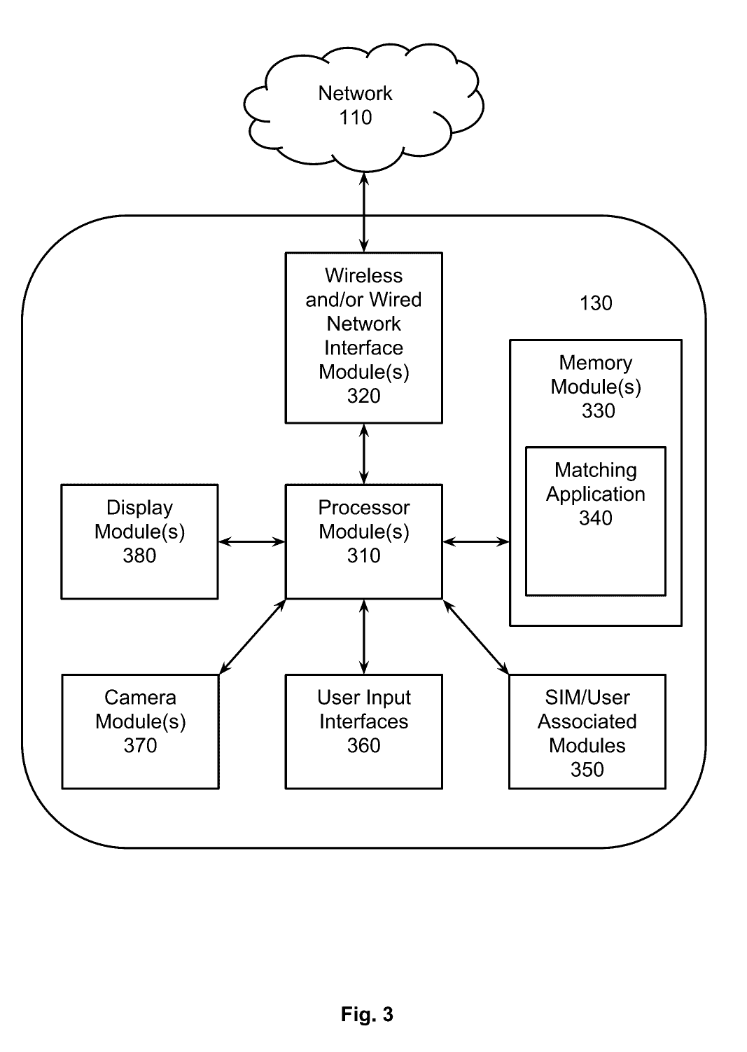

FIG. 3 illustrates an exemplary user device 130. User device 130 includes one or more processor modules 310 in communication via a system bus with one or more memory modules 330. The memory module 330 contains data as well as program code for a provider-and-consumer matching application (“matching application”) 340 executable by the processor module 310. Execution by the processor module 310 results in, for example, generation of user interface screens facilitating the provider-and-consumer matching described herein. The exemplary user device 130 is configured to send information to, and receive information from, the network 110 via a network interface module 320. In embodiments in which the user device 130 comprises a wireless device, the network interface module 320 may include, for example, a wireless transceiver capable of communicating with devices on network 110. The processor module 310 may also communicate with camera module 370 and a SIM/user-associated module 350. Users may interact with the client device 130 via one or more user input interfaces 360 and a display module 380.

An exemplary matching application 340 may comprise HTML data, images, icons, and/or executable code. The executable code may be composed in JavaScript, ECMAscript, CoffeeScript, Python, Ruby or other programming languages suitable for execution within the matching application 340, or translation into a client application executable form.

The matching application 340 is typically adapted to present various user interfaces to a user. Such user interfaces may be based on information sent by the provider-and-consumer matching system, and may allow the user to send and receive data. The matching application 340 may allow the user to create and/or manipulate content items, filters, preferences, etc. via various user interfaces, and to communicate the same to the host server system 120.

It will be apparent to one of ordinary skill in the art that, in certain embodiments, any of the functionality of the user device 130 may be incorporated into the host server system 120, and vice versa. Likewise, any functionality of a matching application 340 may be incorporated into a browser-based client, and such embodiments are intended to be fully within the scope of the invention. For example, a browser-based provider-and-consumer matching application could be configured for offline work by adding local storage capability, and a native application could be distributed for various native platforms via a software layer that executes the browser-based program on the native platform.

In one embodiment, communication between a provider-and-consumer matching application and a provider-and-consumer matching program may involve the use of a translation and/or serialization module. A serialization module can convert an object from an in-memory representation to a serialized representation suitable for transmission via HTTP or another transport mechanism. For example, the serialization module may convert data from a native Python, Ruby, or Java in-memory representation into a JSON string for communication over the client-to-server transport protocol.

Similarly, communications of data between the user device 130 and the host server system 120 may be continuous and automatic, or may be user-triggered. For example, the user may click a button, causing the client to send data to the host server system 120. Alternately, a matching application 340 may automatically send updates to the host server system 120 periodically without prompting by a user. If a user device 130 sends data autonomously, the host server system 120 may be configured to transmit this data, either automatically or on request, to additional user devices 130, thereby enabling multi-user online concurrent editing of the same document.

The server may be capable of communicating user-populated and/or automatically-populated database table entries to third party systems, and may notify users of such communications.

It will be recognized that any other suitable software or hardware or combinations thereof may be used with the exemplary provider-and-consumer matching systems and applications disclosed herein. Moreover, such applications may be implemented at any suitable location in FIG. 1, such as but not limited to at the host server system 120, at the user device 130, or at a location not pictured.

Unless specifically stated otherwise, as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

Generally, the systems and methods disclosed herein can be implemented by hardware, software, firmware, middleware, microcode, or any combination thereof, or is implemented on a cloud-based or visualized network system. In one embodiment, the techniques disclosed herein may be implemented in software such as an operating system or in an application running on an operation system. In another embodiment, the system may be integrated into a mobile application that allows users to interact with a provider-and-consumer matching system via a mobile application. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameter, or memory contents. Information, arguments, parameters, data, etc. may be passed, forwarded, or transmitted through any suitable means including memory sharing, message passing, token passing, network transmission, etc.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a flash memory device, such as a compact flash card or USB flash drive.

Some exemplary embodiments described herein are described as software executed on at least one computer, though it is understood that embodiments can be configured in other ways and retain functionality. The embodiments can be implemented on known devices such as a server, a personal computer, a special purpose computer, a programmed microprocessor or microcontroller and peripheral integrated circuit element(s), and ASIC or other integrated circuit, a digital signal processor, a hard-wired electronic or logic circuit such as a discrete element circuit, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The terms determine, calculate and compute, and variations thereof, as used herein are used interchangeably and include any type of methodology, process, mathematical operation or technique.

The invention described and claimed herein is not to be limited in scope by the specific embodiments herein disclosed since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

It will be apparent to one of ordinary skill in the art that the examples provided herein involving specific programming languages, scripting languages, data formats, specific software or programs, and other details are exemplary and that variations on any of these details are aspects of and are intended to be within the scope of the present invention. For example, although a provider-and-consumer matching program may be described herein as being separate from a communication program, it will be appreciated that a single program may include the functionality of both programs.

Process Flow

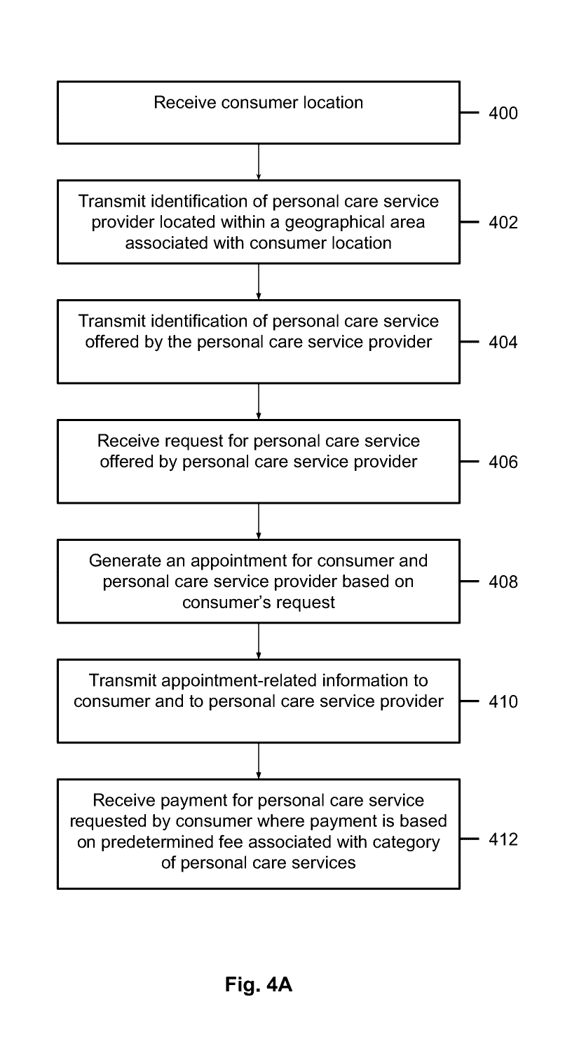

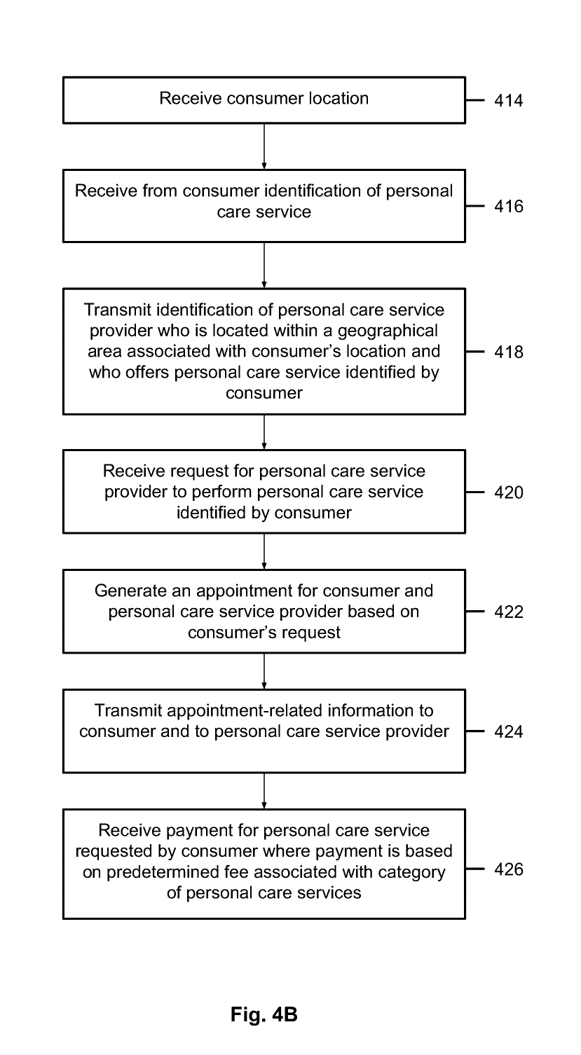

FIG. 4A is a flow diagram illustrating a method for matching providers and consumers of personal care services according to one embodiment of the present disclosure. At step 400, a host server system 120 receives a consumer location from a consumer. At step 402, the host server system 120 transmits an identification of a personal care service provider located within a geographical area associated with the consumer location. At step 404, the host server system 120 transmits an identification of a personal care service offered by the personal care service provider. At step 406, the host server system 120 receives from the consumer a request for the personal care service offered by the personal care service provider. At step 408, the host server system 120 generates an appointment for the consumer and the personal care service provider based on the consumer's request. At step 410, the host server system 120 transmits appointment-related information to the consumer and to the personal care service provider. At step 412, the host server system 120 receives a payment for the personal care service requested by the consumer where the payment is based on a pre-determined fee associated with a category of personal care services.

FIG. 4B is a flow diagram illustrating a method for matching providers and consumers of personal care services according to another embodiment of the present disclosure. At step 414, a host server system 120 receives from a consumer a location associated with the consumer. At step 416, the host server system 120 receives from the consumer an identification of a personal care service. At step 418, the host server system 120 transmits to the consumer an identification of a personal care service provider who is located within a geographical area associated with the consumer's location and who offers the personal care service identified by the consumer. At step 420, the host server system 120 receives from the consumer a request for the personal care service provider to perform the personal care service identified by the consumer. At step 422, the host server system 120 generates an appointment for the consumer and the personal care service provider based on the consumer's request. At step 424, the host server system 120 transmits appointment-related information to the consumer and to the personal care service provider. At step 426, the host server system 426 receives a payment for the personal care service requested by the consumer where the payment is based on a pre-determined fee associated with a category of personal care services.

The consumer's location may be based on GPS coordinates, an area defined by a center point and a radius, a rectangle defined by four GPS coordinates, a predefined area corresponding to a political designation (e.g. “the city of New Orleans”), or any other type of location designation. When a consumer's location is defined using a center point and a radius, the center may be the sending user's current location in GPS coordinates, another location in GPS coordinates, a city center, or any other type of data capable of defining a center point. The radius may be a distance measured in units for measuring distance (e.g., miles, kilometers, feet, or meters) or may be a relative distance designation (e.g., “nearby”, “within city”, “within state”, etc.).

Whether a provider is located within a geographical area associated with a customer's location may be determined in various ways. For example, a geographical area may be defined as an area within a certain radius of the consumer's location. If the radius is set at 20 miles and the consumer's location is a location in GPS coordinates, then, in this example, a provider would be considered located within the geographical area associated with the consumer's location if the provider is located within 20 miles of the consumer's GPS coordinates. As another example, a geographical area may be defined as a metropolitan area surrounding the consumer's location. If a consumer's location is a neighborhood within a city (e.g. the French Quarter of New Orleans), then, in this example, a provider would be considered located within the geographical area associated with the consumer's location if the provider is in the metropolitan area surrounding the neighborhood (e.g. the greater New Orleans metropolitan area, which surrounds the French Quarter). Many different approaches are possible for determining whether a provider is located within an area associated with a consumer's location.

Methods for identifying consumers and providers on a map and determining their location and proximity relative to each other may include various location technologies, such as Apple GPS Location Services and Android GPS Location Services. Of course, other location and mapping technologies may be used as well.

Apple GPS Location Services

In one embodiment, for Apple devices, location services within the Core Location framework are used for obtaining information about a user's most recent location. Using iBeacon technology and Bluetooth low-energy beacons that advertise the same universally unique identifier (UUID), a beacon region is formed so that the matching application 340 can monitor a user's most recent location. (A user may be a provider or a consumer.) Beacons with the same UUID are distinguished by utilizing additional information they advertise. While a beacon is in range of a user's device, the matching application 340 monitors for the relative distance to the beacon to track the last known location of a provider or consumer's device. The Core Location framework provides the services to locate the current position of a user's device. The framework reports the device's location and also provides periodic updates as it receives new or improved data. The standard location service is configured for getting location data and tracking location changes for the specified level of accuracy. The significant-change location service is configured to deliver updates only when there has been a significant change in the device's location, such as 500 meters or more.

Android GPS Location Services

In another embodiment, location APIs provided by Google Play services facilitate location awareness with automated location tracking, geo-fencing, and activity recognition. When a user's location is needed, the matching application 340 requests the last known location of a user's device, which is typically the user's current location. Specifically, the matching application 340 uses the fused location provider to retrieve the device's last known location. The fused location provider is also one of the location APIs in Google Play services, and it manages the underlying location technology and allows the matching application 340 to use specific requirements at a high level, such as “high accuracy” or “low power”. The fused location provider also optimizes the device's use of battery power. The matching application 340 may continuously track location so that it can deliver up-to-date information to the provider or consumer. For example, if the provider relocates and is still available to provide services, the matching application 340 may retrieve the location of the provider's device at regular intervals.

Pre-Determined Fees

In some embodiments, payment may be based on a pre-determined fee associated with a category of personal care services. A pre-determined fee may be provided to allow a consumer to know the price he or she will pay before the consumer actually receives the service. Likewise, the pre-determined fee may be provided to allow the service provider to know the price he or she will receive for rendering the service before the service is actually rendered. In addition, the pre-determined fee may vary according to factors such as geographical region, time of day, day of the week, and demand for a given service. For example, a man's haircut may be priced at $75 in Manhattan but only $50 in New Orleans. As another example, a massage may be priced at $100 on weekends and evenings when demand is high, but may be priced at only $75 on weekday mornings when demand is lower. The matching system 100 may also vary prices depending on current demand or projected demand for a service.

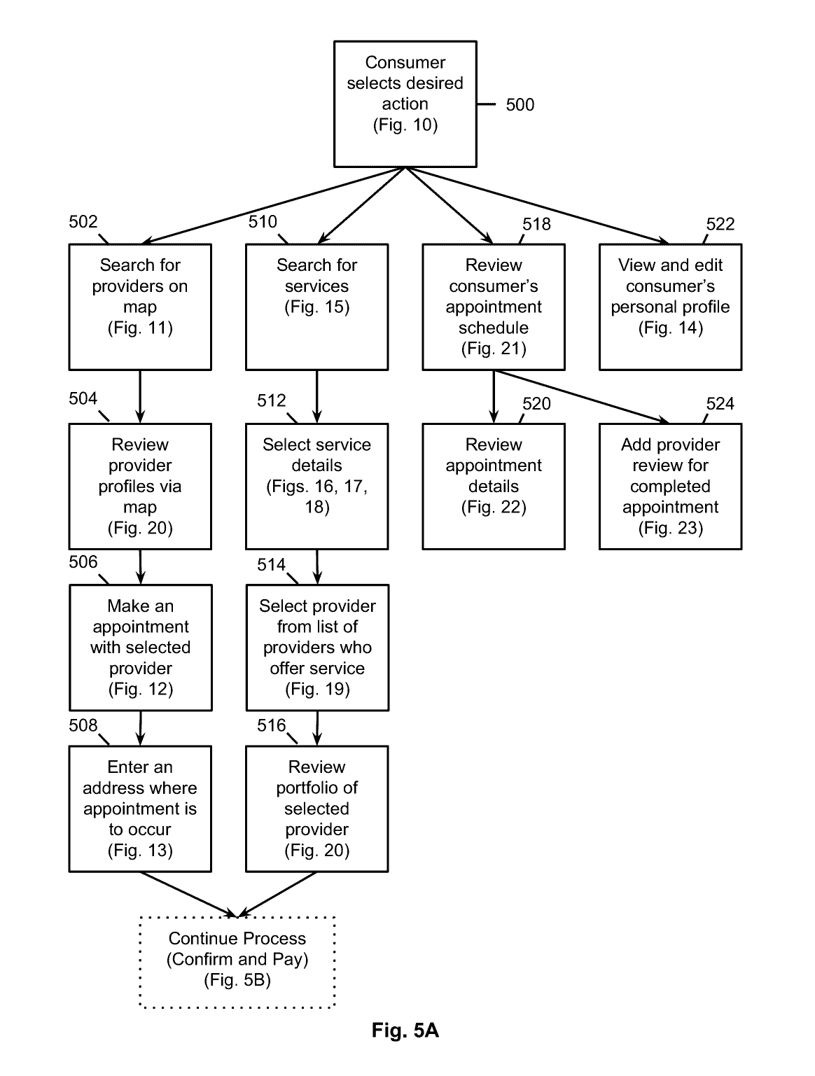

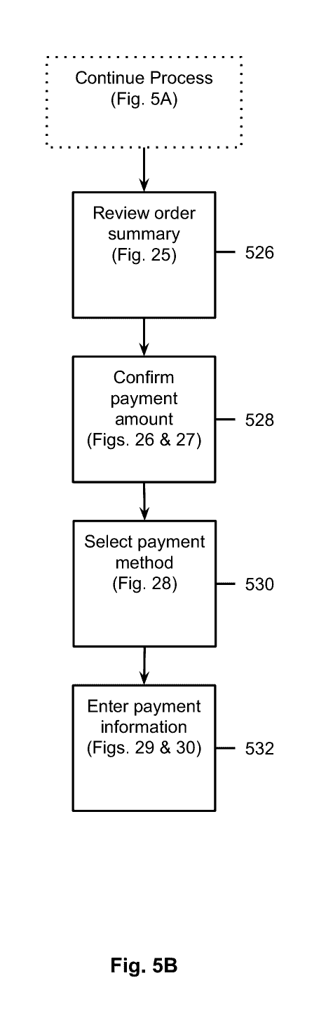

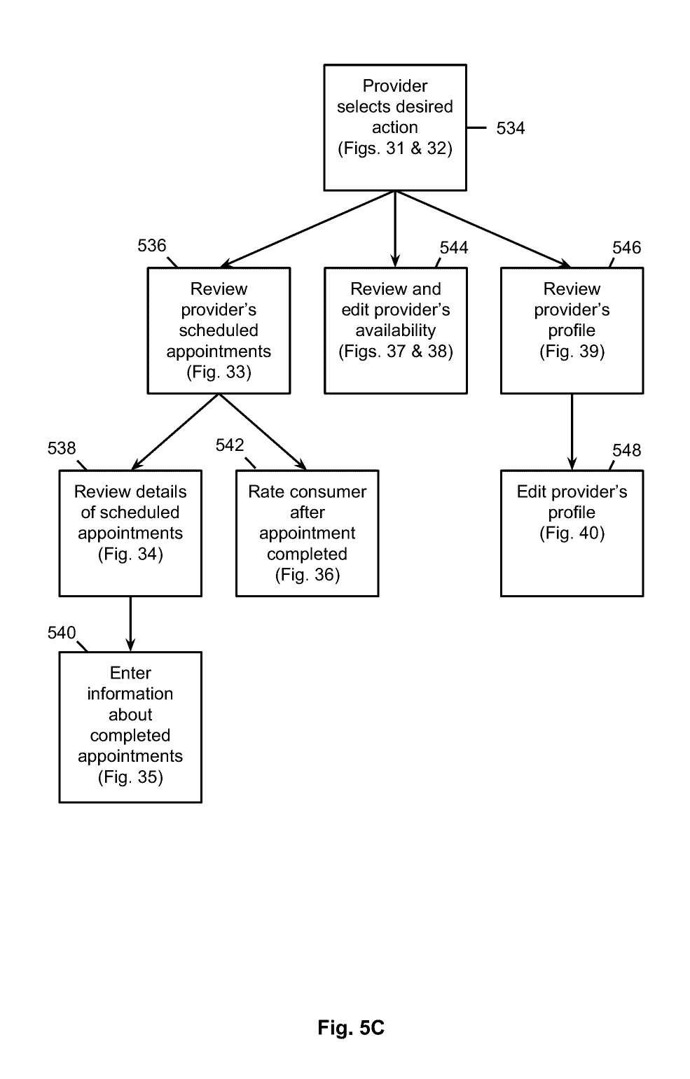

FIG. 5A is a flow diagram illustrating various functions that may be provided to consumers as part of the matching application 340. Figure numbers appearing in each box correspond to figures showing exemplary screens for performing the identified functions. Of course, some of these functions may be omitted and, likewise, other functions may be added. At step 500, a consumer selects a desired action from a menu within matching application 340. Among other things, menu options may include: 1) searching first for providers (and then selecting services offered by the provider), 2) searching first for services (and then selecting a provider from a list of providers who offer those services), 3) reviewing a consumer's appointment schedule, and 4) editing a consumer's personal profile.

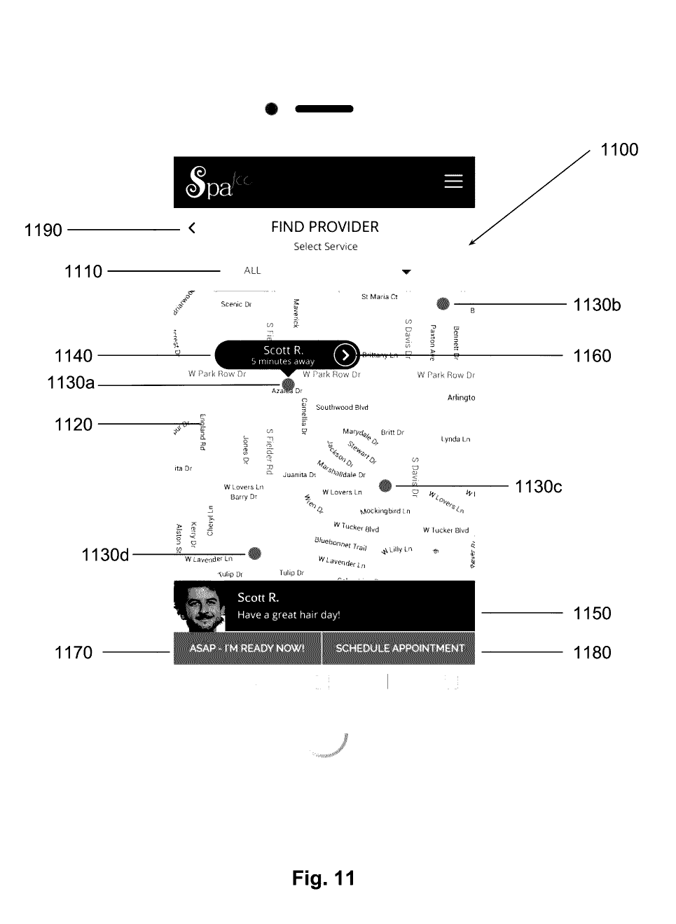

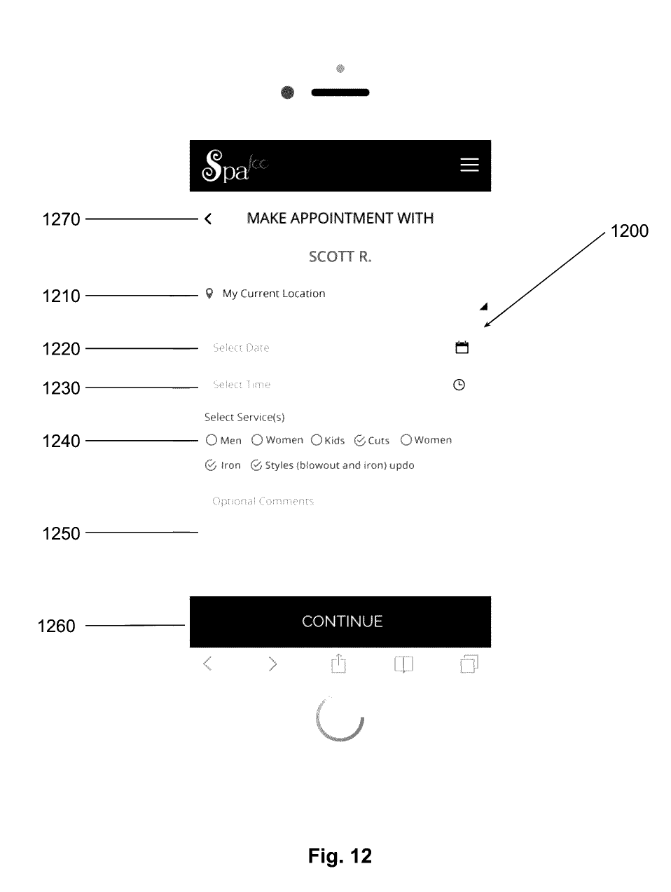

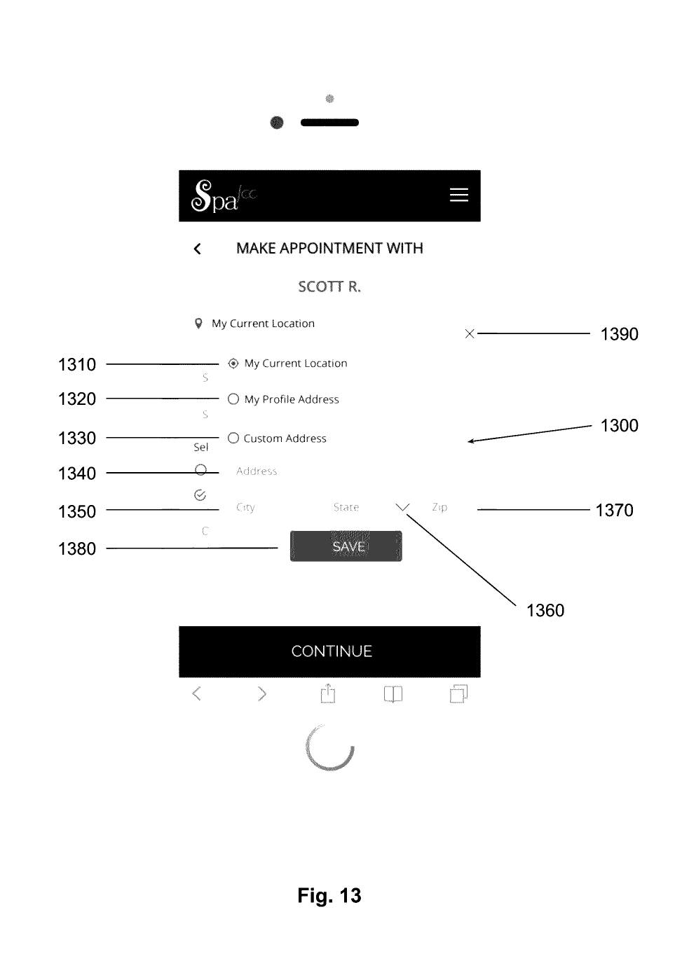

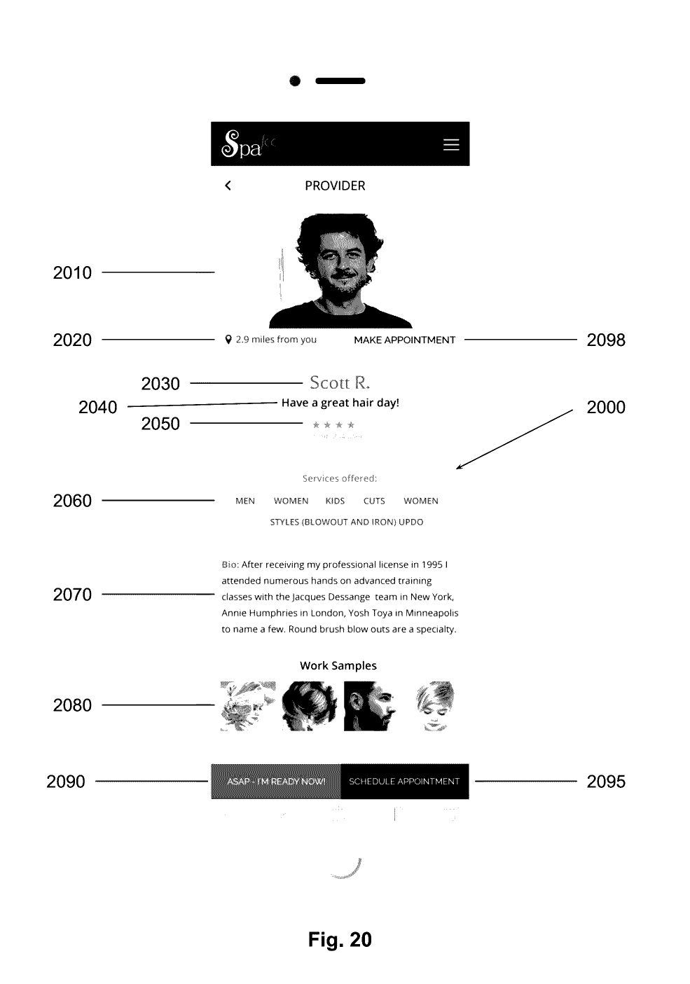

If a consumer opts to search first for providers and then select services offered by the provider, the consumer may proceed to steps 502 through 508. At step 502, the consumer searches for service providers on a map (see FIG. 11). At step 504, the consumer reviews provider profiles via a map interface (see FIG. 20). At step 506, the consumer makes an appointment with a selected provider (see FIG. 12). At step 508, the consumer enters an address where an appointment is to occur (see FIG. 13). The consumer then proceeds to step 526.

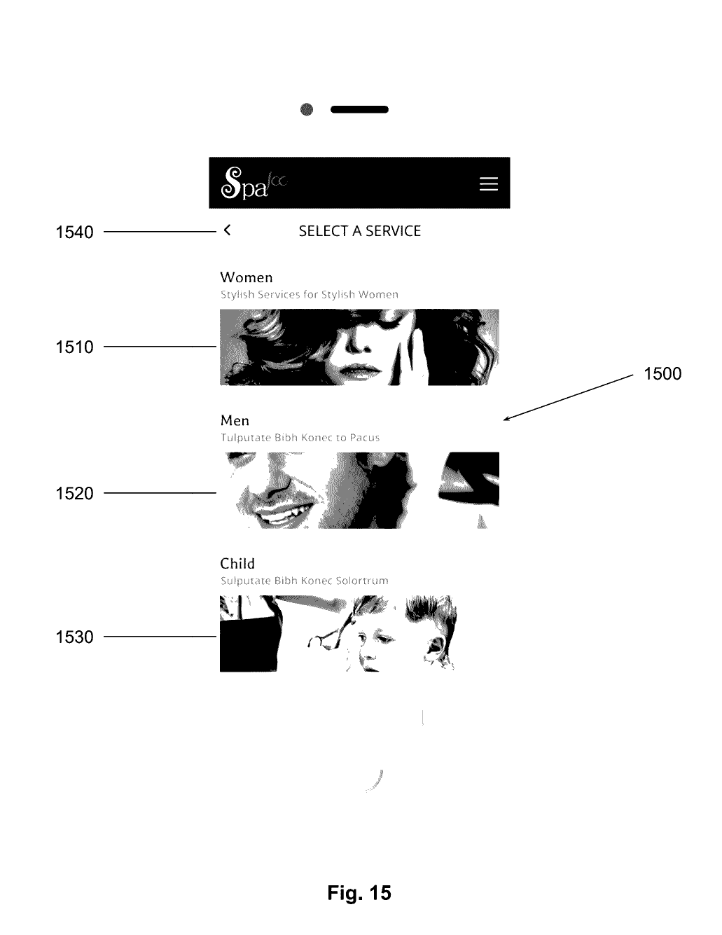

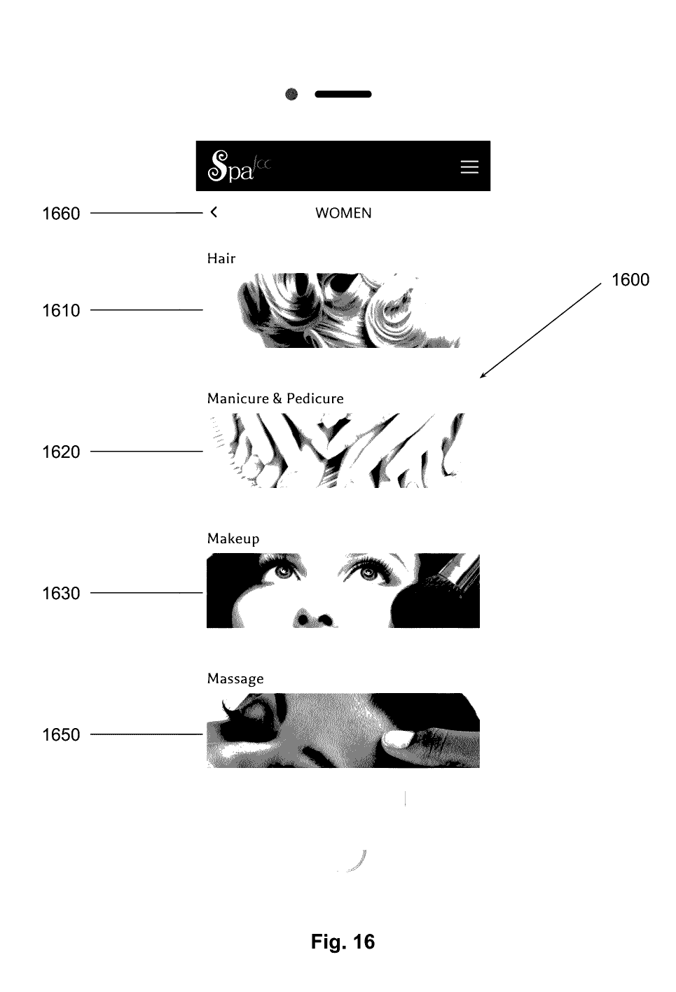

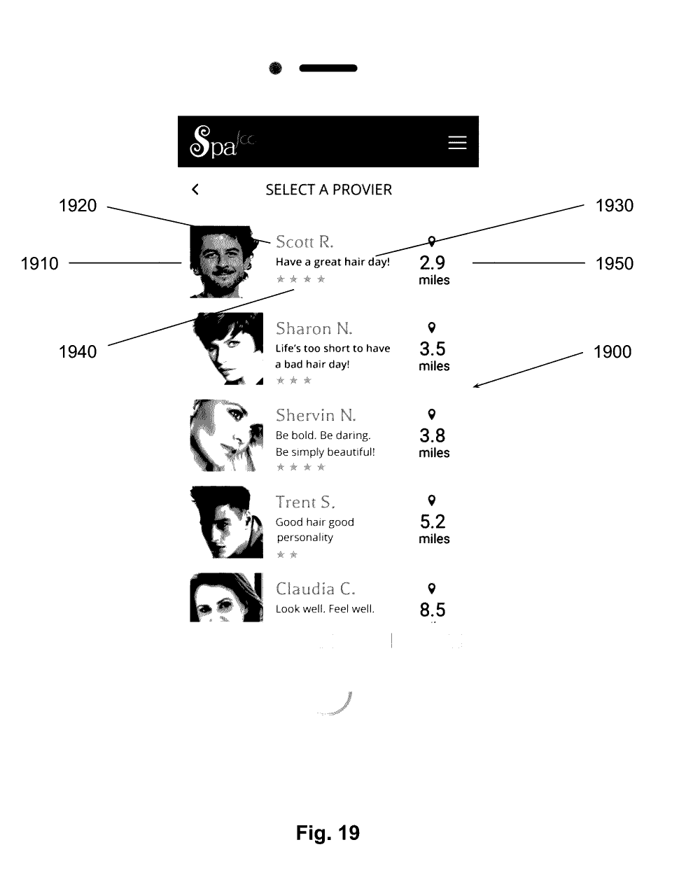

If a consumer opts to search first for services and then select a provider from a list of providers who offer those services, the consumer may proceed to steps 510 through 516. At step 510, the consumer searches for services (see FIG. 15). At step 512, the consumer selects service details (see FIGS. 16, 17, and 18). FIGS. 16-18 depict an exemplary menu tree for hair cutting services. Of course, consumers may search for many other types of personal care services, such as massages and facial care. The consumer may select service details in various ways, including by checking checkboxes, selecting from dropdown lists, and navigating through a tree structure. Using hair cutting services as an example, if the desired service is a woman's haircut for straight hair (and assuming the selection method is the option tree depicted in FIGS. 16-18), the consumer would select the following options: “women” (from among “women,” “men,” and “children”), then “hair” (from among “hair,” “manicure & pedicure,” “makeup,” and “massage”), then “wavy” (from among “straight,” “wavy,” and “curly”), and then “haircut” (from among “haircut,” “style (roundbrush or iron),” and “updo/braid”). Of course, many other selection methods are possible and many other services could be presented as options. At step 514, the consumer may select a provider from a list of providers who offer the selected service (see FIG. 19). At step 516, the consumer may review a portfolio of the selected provider (see FIG. 20). The consumer then proceeds to step 526.

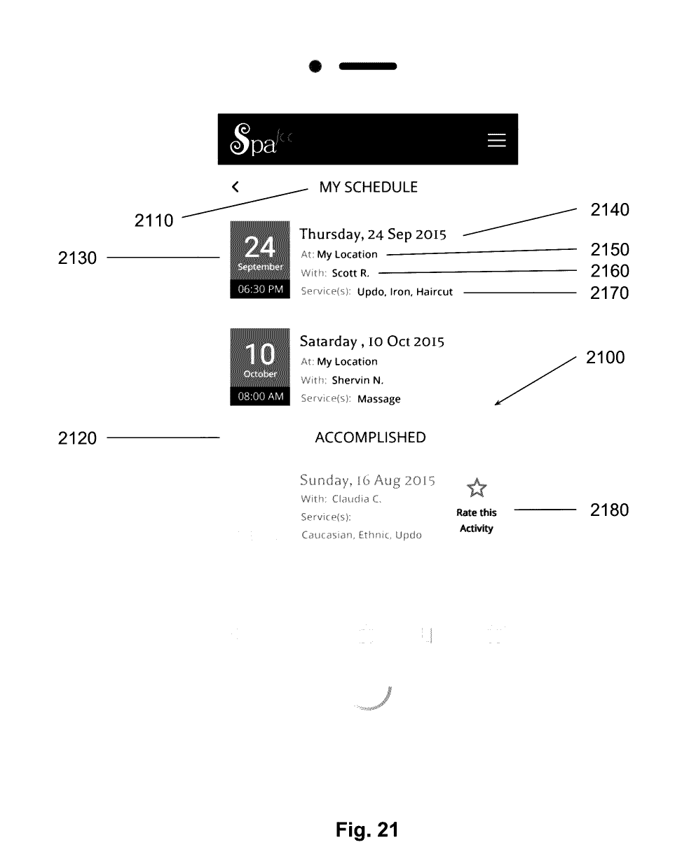

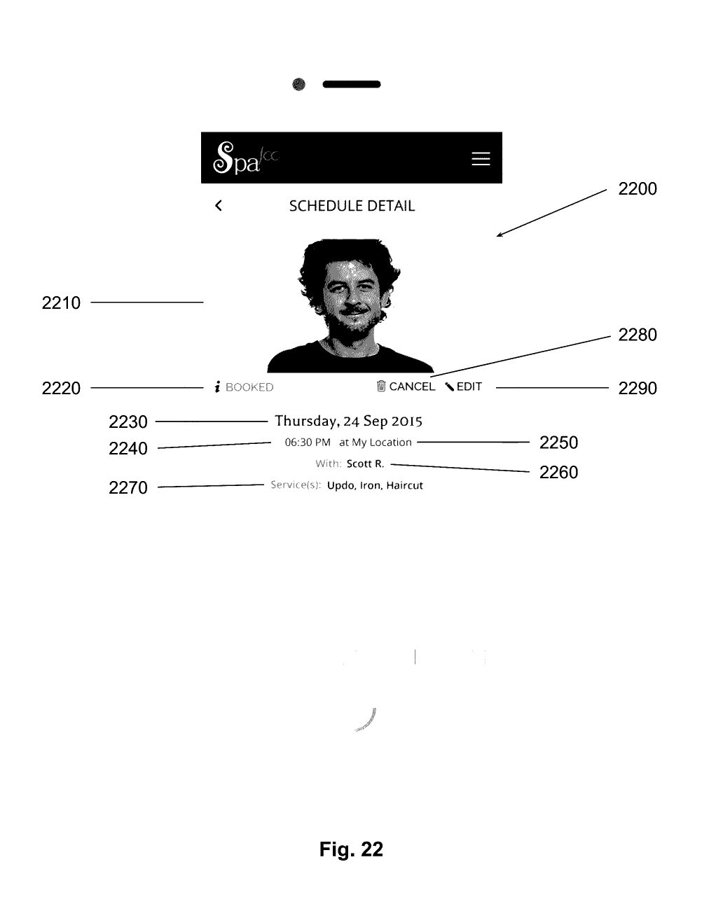

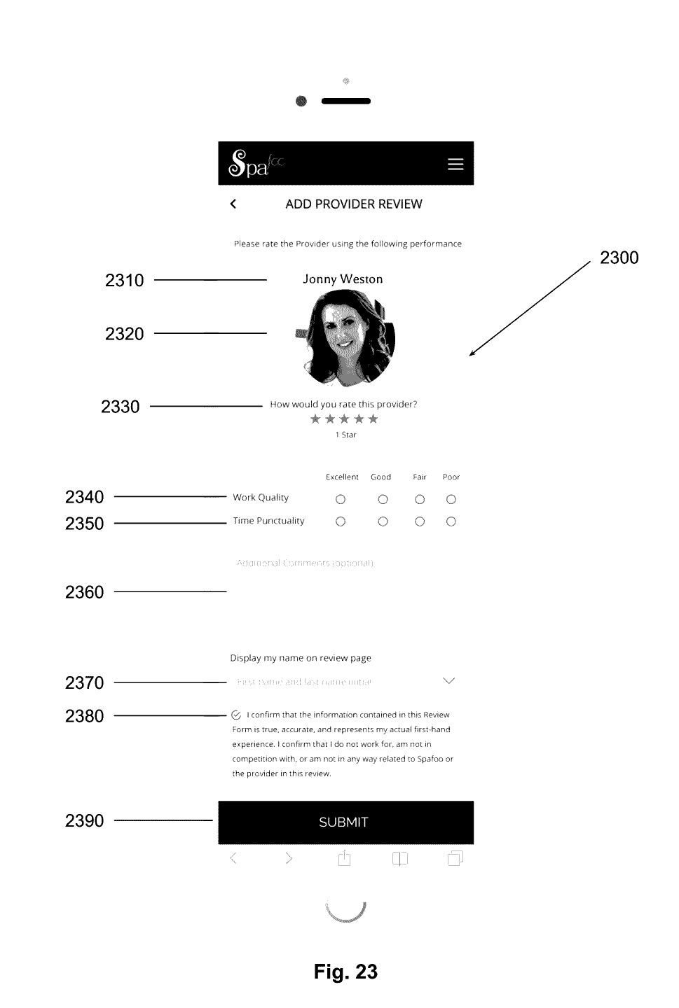

If a consumer opts to review his or her scheduled appointments, the consumer may proceed to step 518. At step 518, the consumer may review the consumer's appointment schedule (see FIG. 21). At step 520, the consumer may review appointment details (see FIG. 22). At step 524, the consumer may add a provider review for a completed appointment (see FIG. 23).

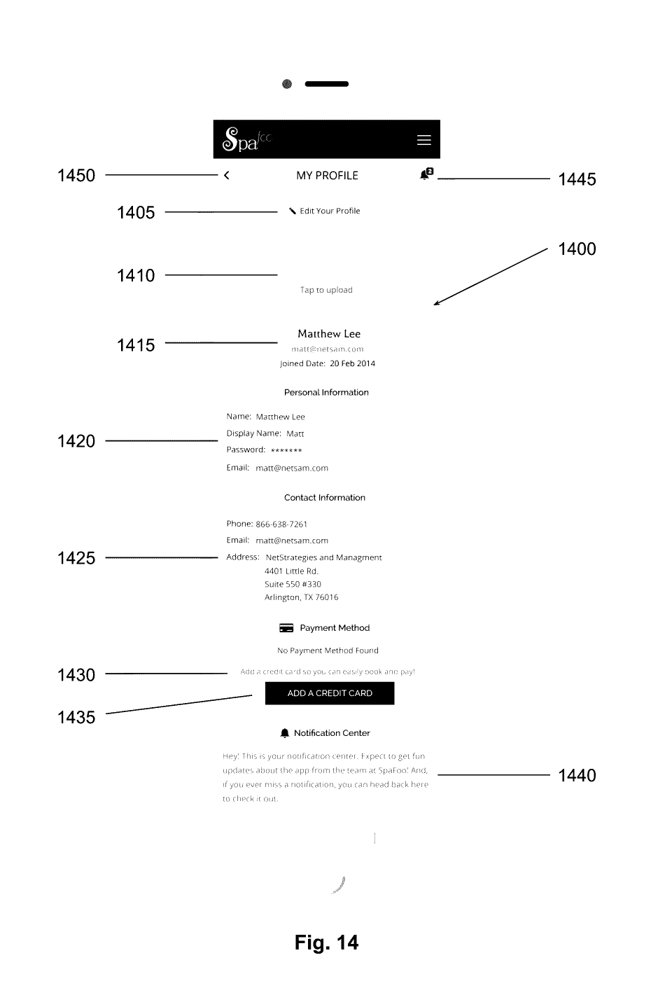

If a consumer opts to review his or her personal profile, the consumer may proceed to step 522 (see FIG. 14).

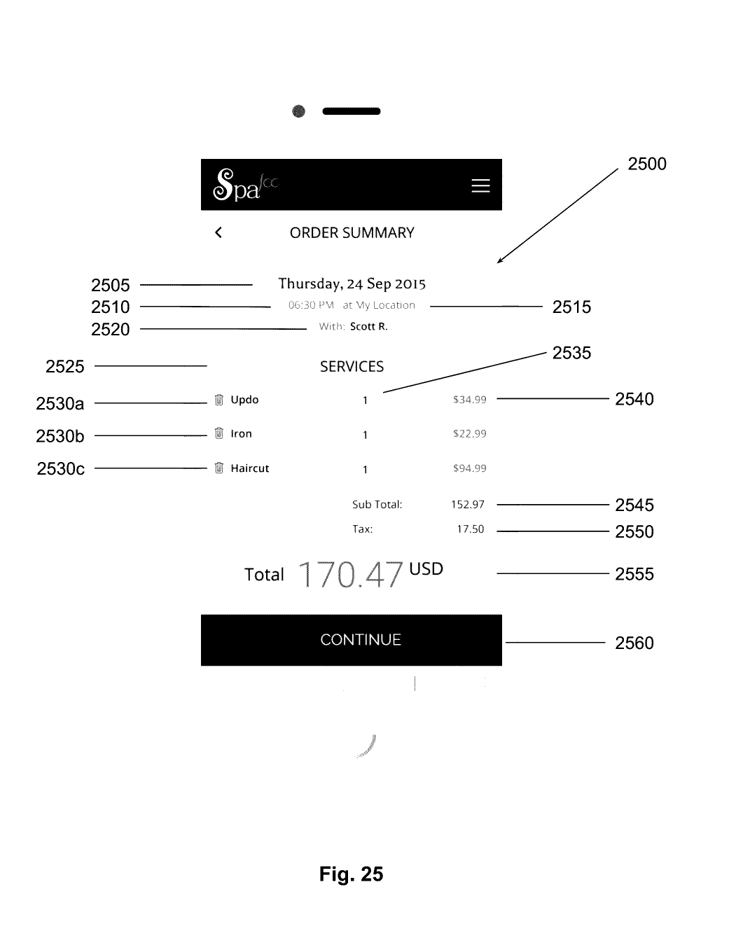

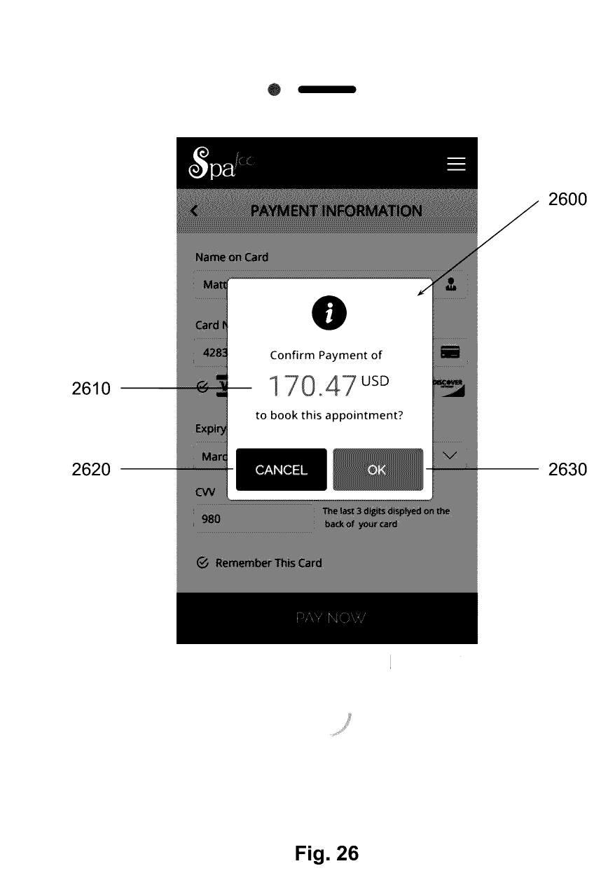

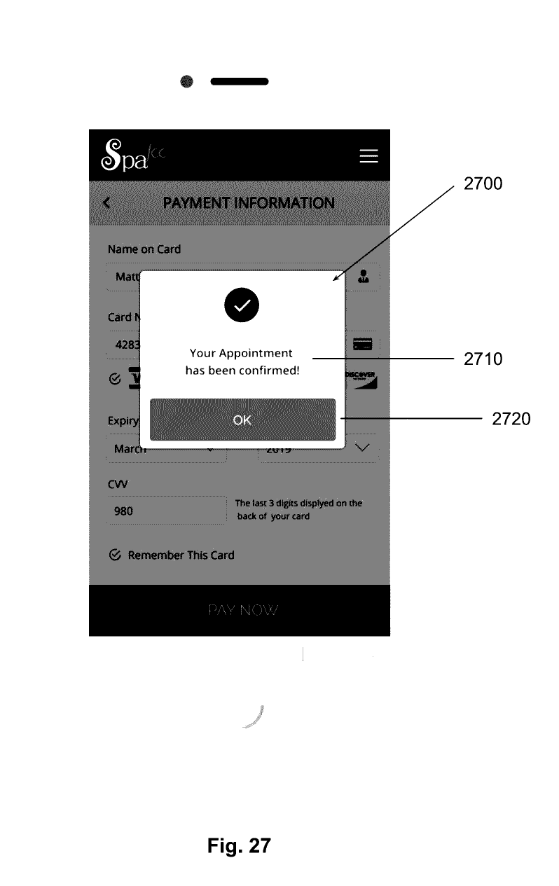

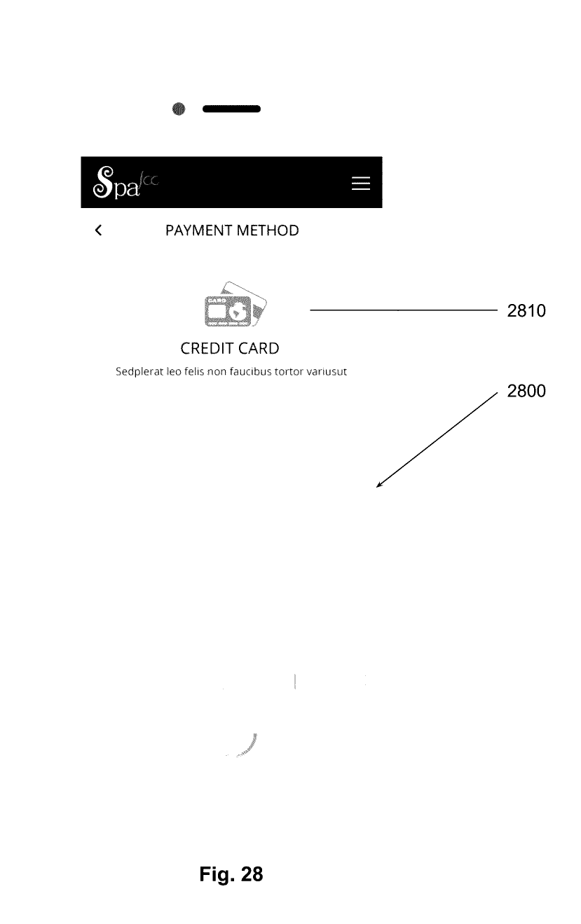

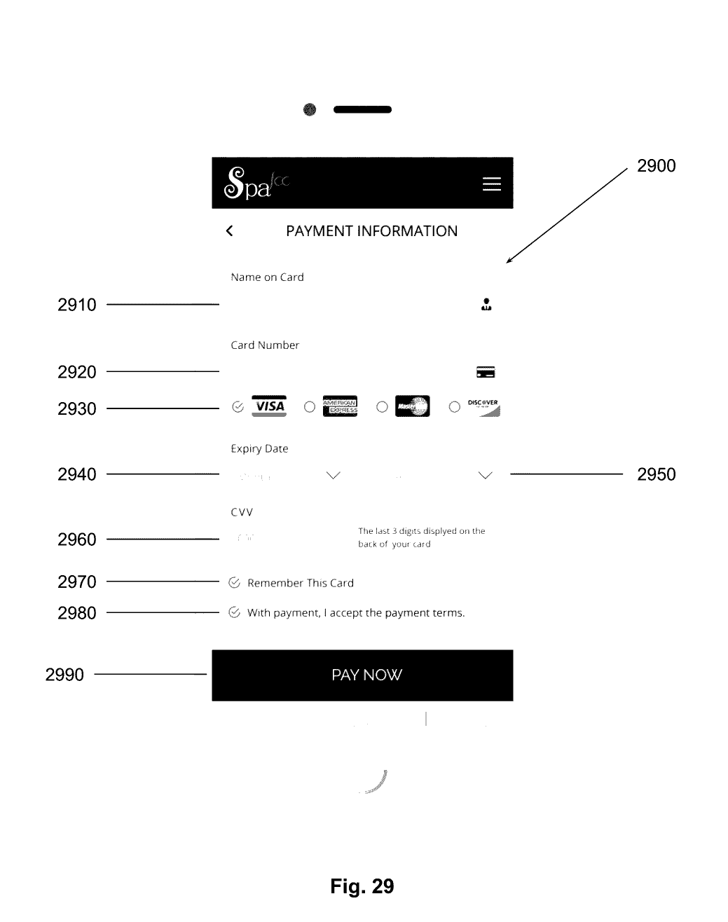

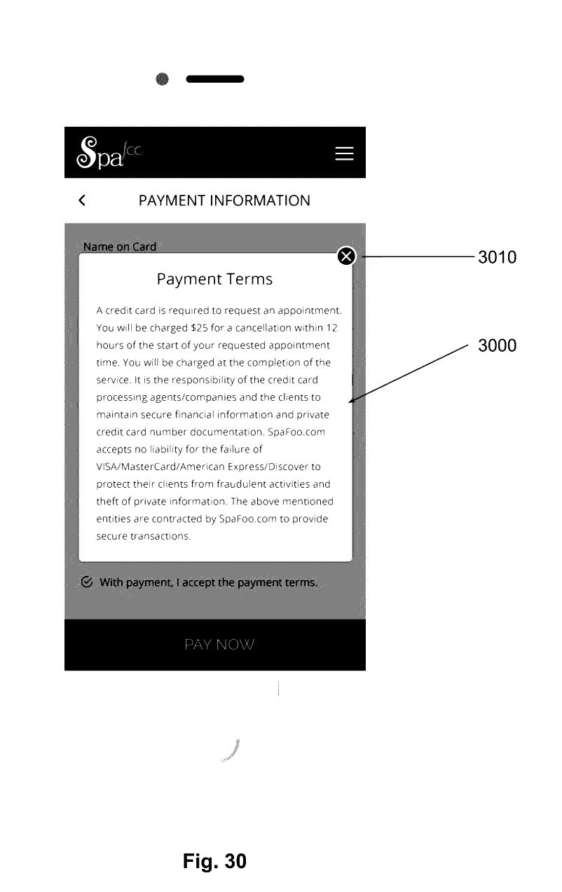

FIG. 5B is a continuation of FIG. 5A. Continuing from steps 508 or 516 from FIG. 5A, at step 526 in FIG. 5B, the consumer may review an order summary (see FIG. 25). At step 528, the consumer may confirm the payment amount (see FIGS. 26 and 27). At step 530, the consumer may select a payment method (see FIG. 28). At step 532, the consumer may enter payment information (see FIGS. 29 and 30).

FIG. 5C is a flow diagram illustrating various functions that may be provided to providers as part of the matching application 340. At step 534, a provider selects a desired action from a menu within matching application 340. Among other things, menu options may include: 1) reviewing the provider's scheduled appointments, 2) reviewing and editing the provider's availability, and 3) reviewing the provider's profile.

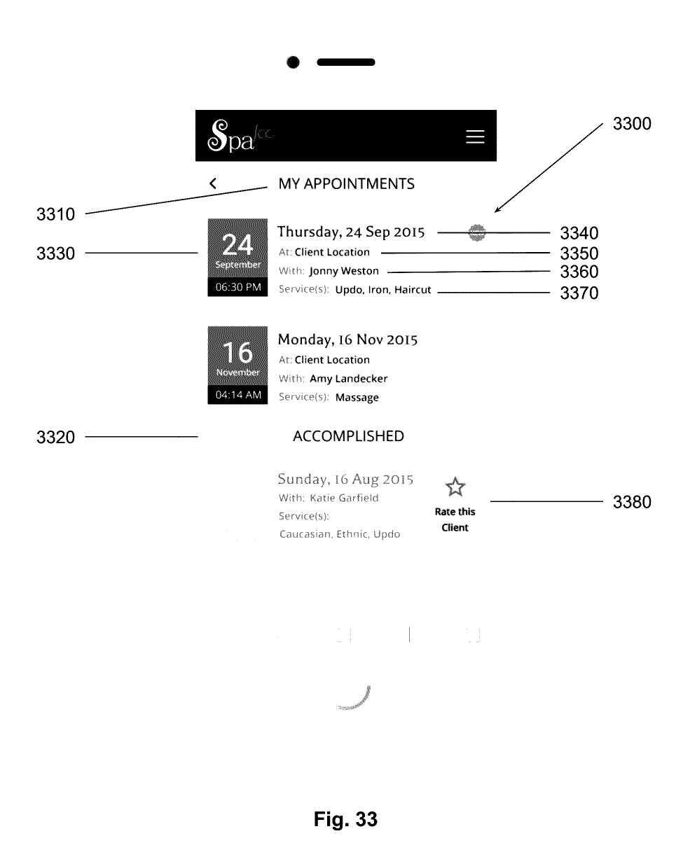

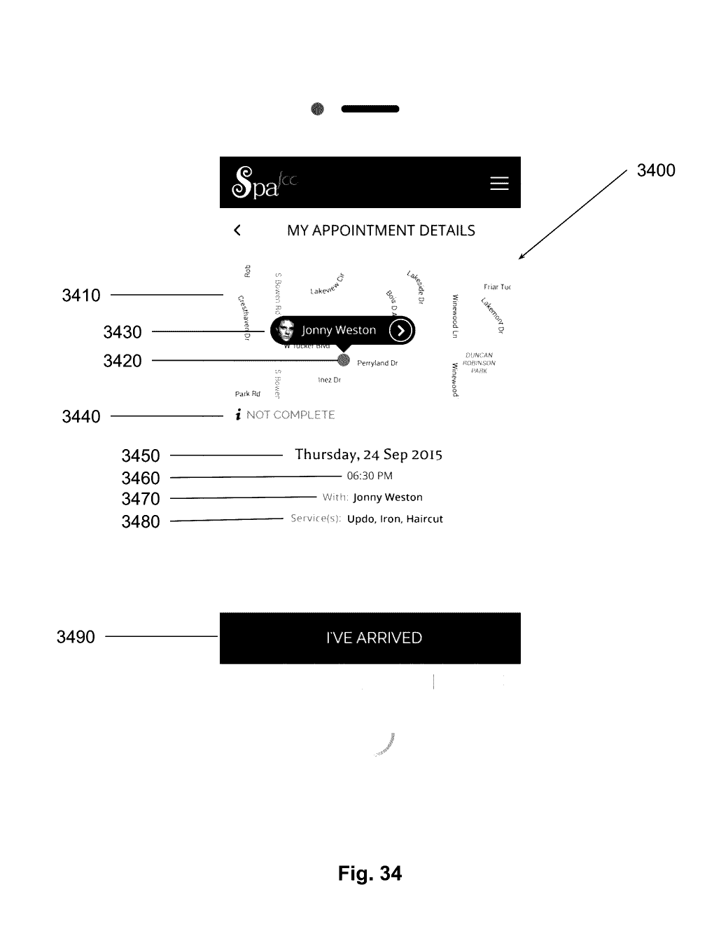

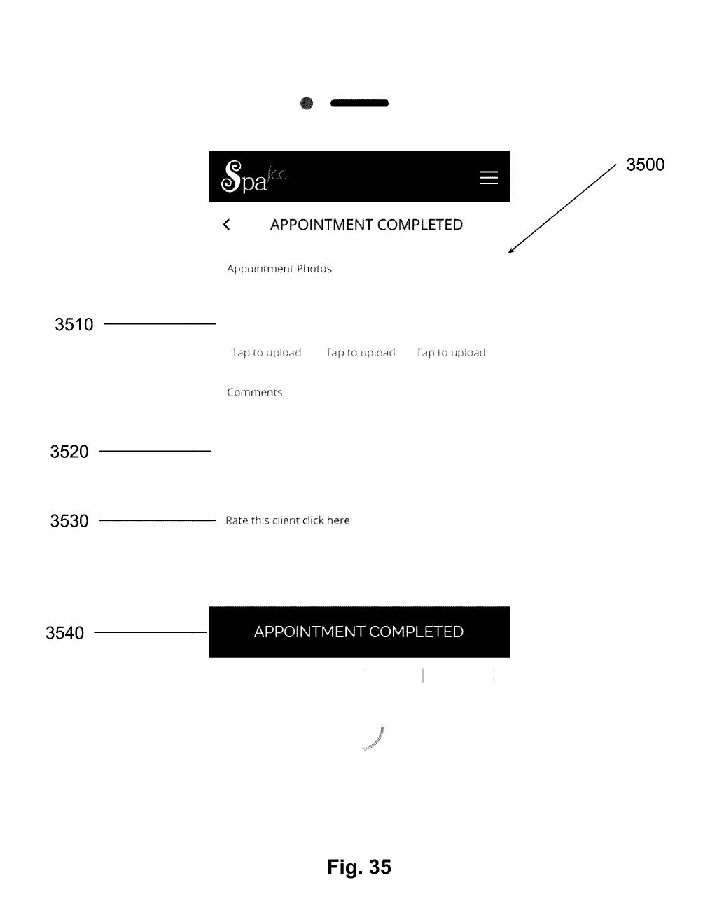

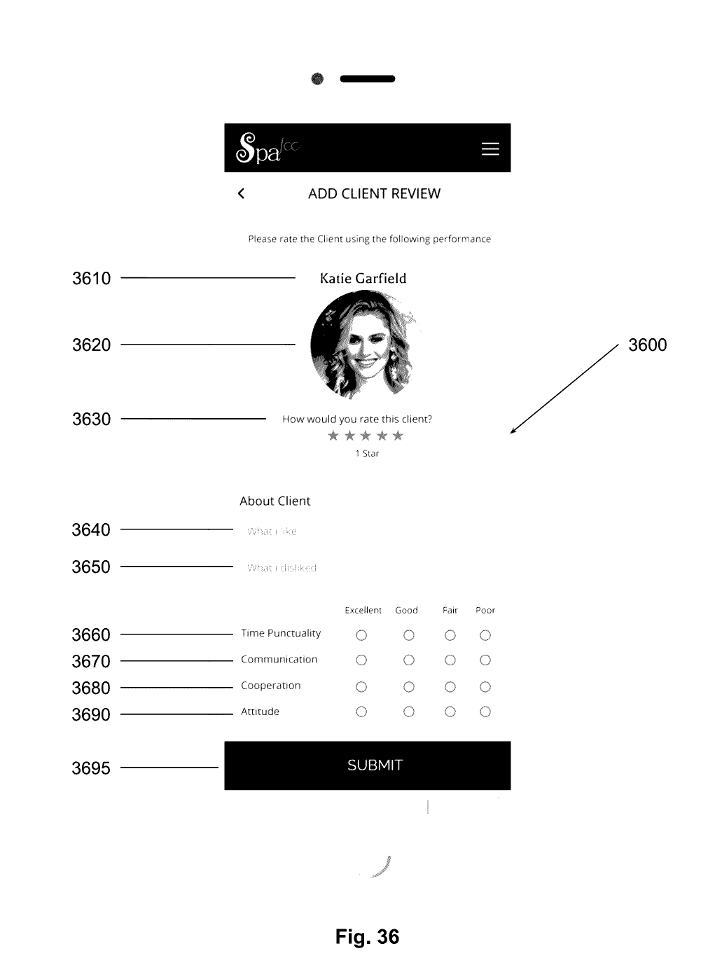

If a provider opts to review his or her scheduled appointments, the provider may proceed to step 536. At step 536, the provider reviews his or her scheduled appointments (see FIG. 33). At step 538, the provider reviews details of scheduled appointments (see FIG. 34). At step 540, the provider enters information about completed appointments (see FIG. 35). At step 542, the provider rates the consumer after the appointment is completed (see FIG. 36).

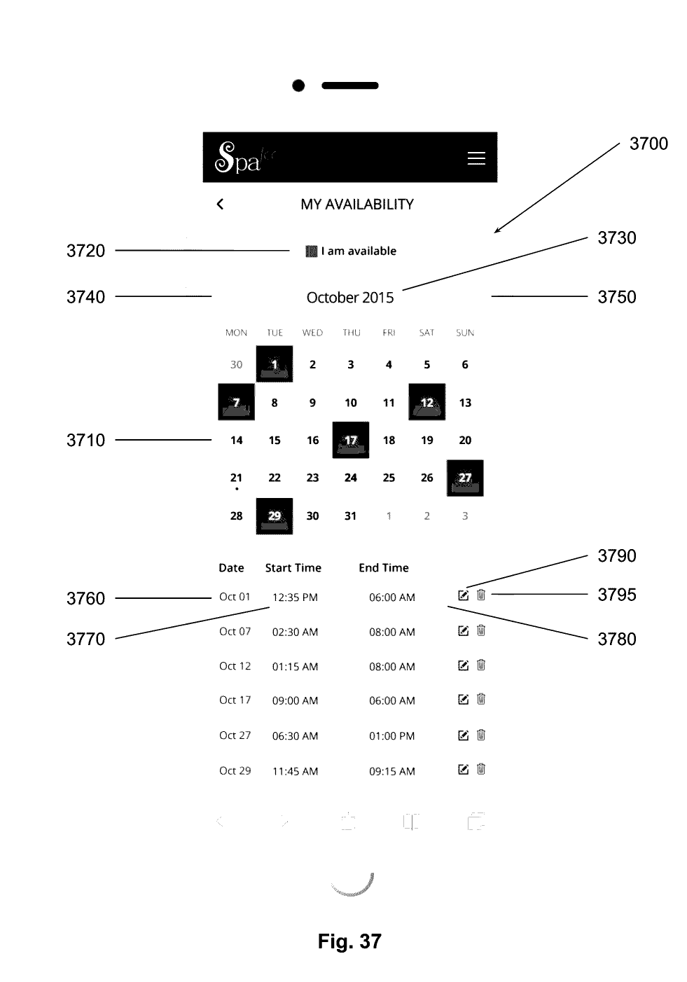

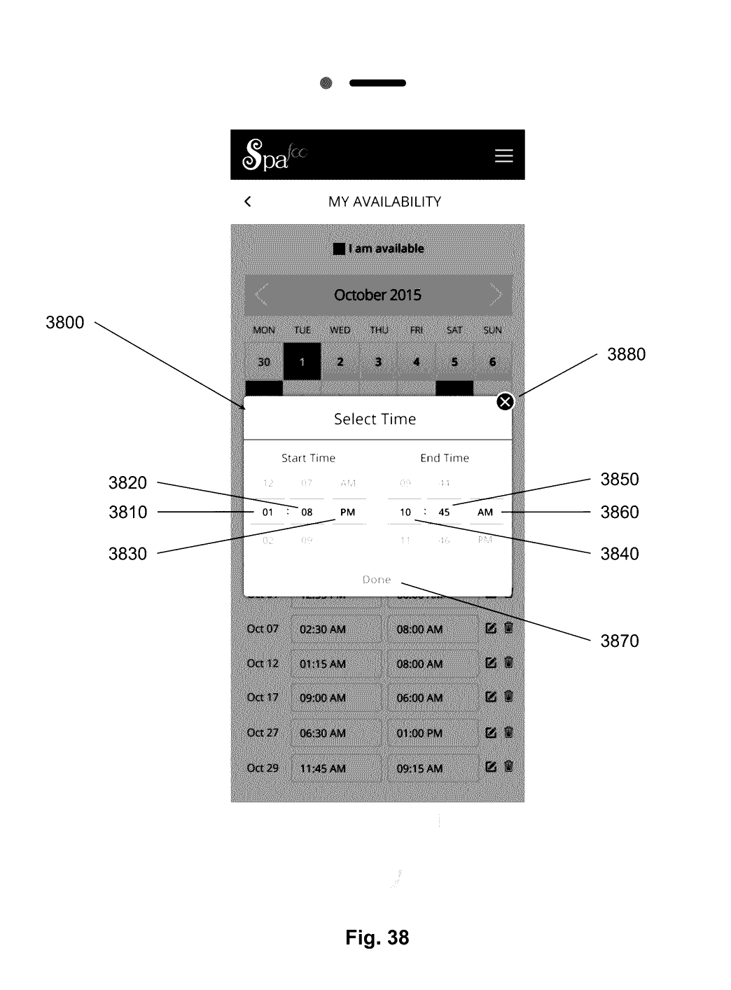

If a provider opts to review or edit the provider's availability, the provider may proceed to step 544. At step 544, the provider may review his or her scheduled appointments (see FIGS. 37 and 38).

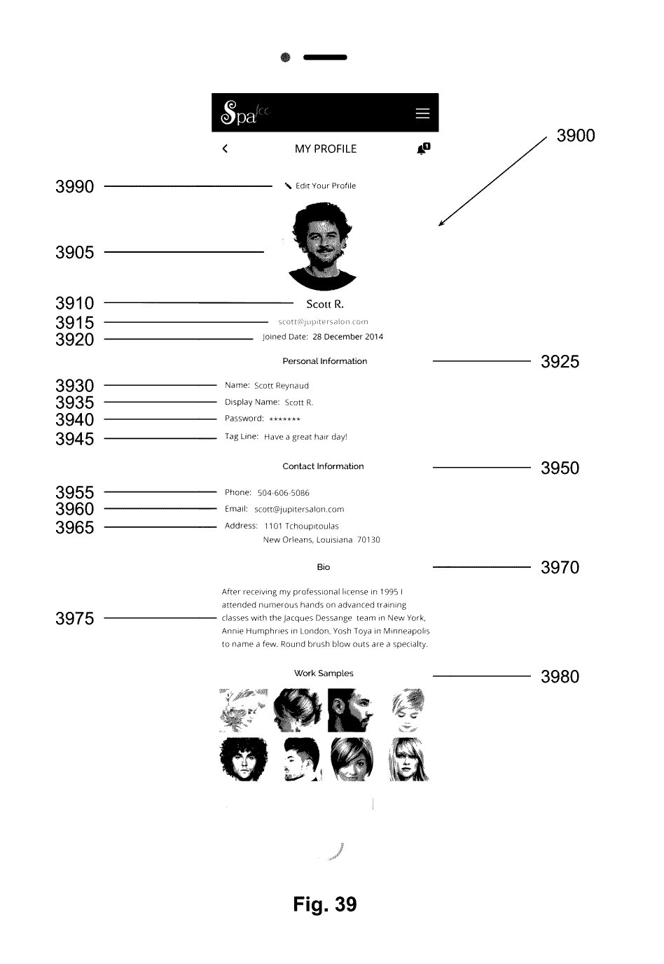

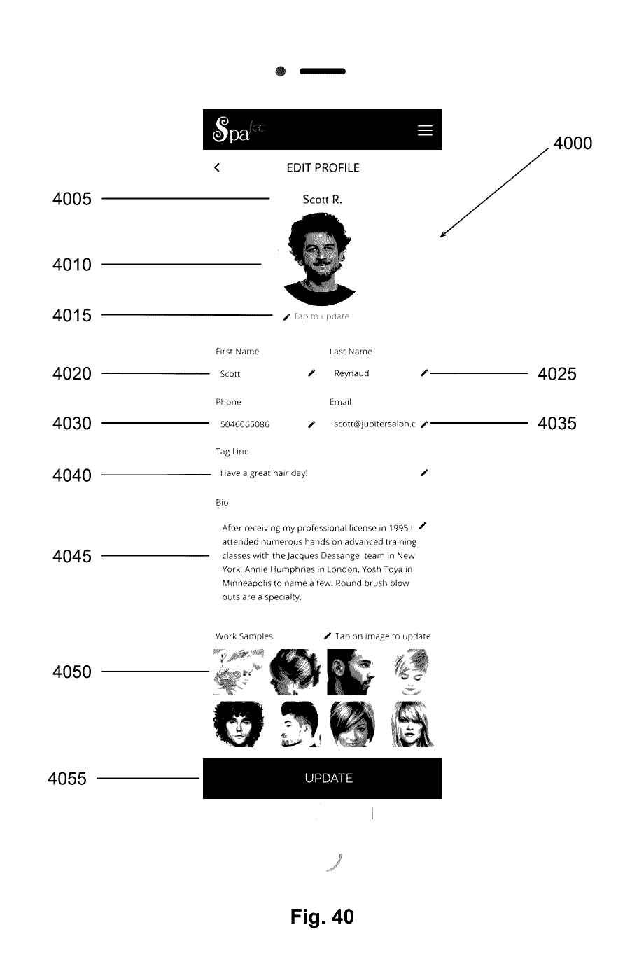

If a provider opts to review the provider's profile, the provider may proceed to step 546 (see FIG. 39). At step 548, the provider may edit the provider's profile (see FIG. 40).

Home Screen

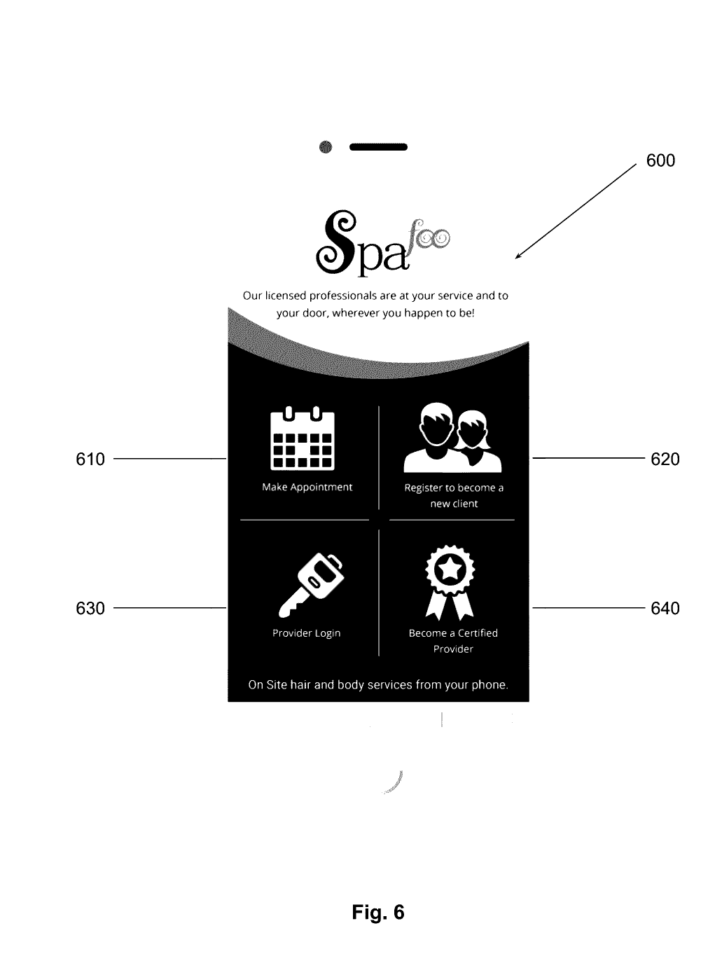

Consumers and providers may share the same home screen in matching application 340, or separate home screens may be provided for either type of user. FIG. 6 illustrates an exemplary home screen 600 in matching application 340 that may be used by both consumers and providers to interact with the system. A button 610 may be provided to allow consumers to make appointments with service providers. A button 620 may be provided to allow new users to register with the system. A button 630 may be provided to allow providers who have already registered with the system to log in. A button 640 may be provided to allow new providers to register with the system.

Signing In

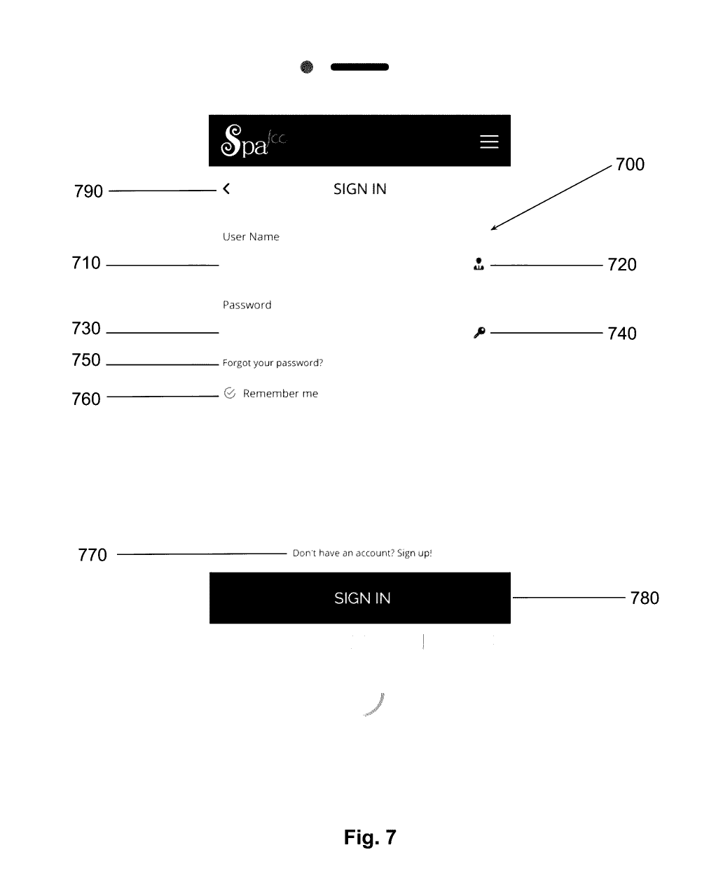

Consumers and providers may use the same screen to sign in to the system (i.e., log in), or separate sign-in screens may be provided for either type of user. FIG. 7 illustrates an exemplary sign in screen 700 that may be used by both consumers and providers to sign in to the matching system 100. A text box 710 allows a user to enter a user name. A symbol 720 appearing within the text box 710 (e.g. a symbol in the shape of a human silhouette) may be provided to denote that a user name should be entered in the text box. A text box 730 allows a user to enter a password. A symbol 740 appearing within the text box 730 (e.g. a key symbol) may be provided to denote that a password should be entered in the text box. A link 750 (e.g. a link labelled “Forgot your password?”) may be provided to send the user to another screen or web page where the user may retrieve a forgotten password or create a new one. A checkbox 760 (e.g. a checkbox labelled “Remember me”) may be provided to allow a user to direct the system to remember the user's sign-in information so that the user will not be required to enter the sign-in information the next time the user uses the system. A link 770 (e.g. a link labelled “Don't have an account? Sign up!”) may be provided to send the user to another screen or web page where the user can create a new account. A button 780 allows the user to complete the sign-in process by directing the system to process the user name and password information entered by the user. A back arrow 790 allows the user to return to the previous screen.

Registration

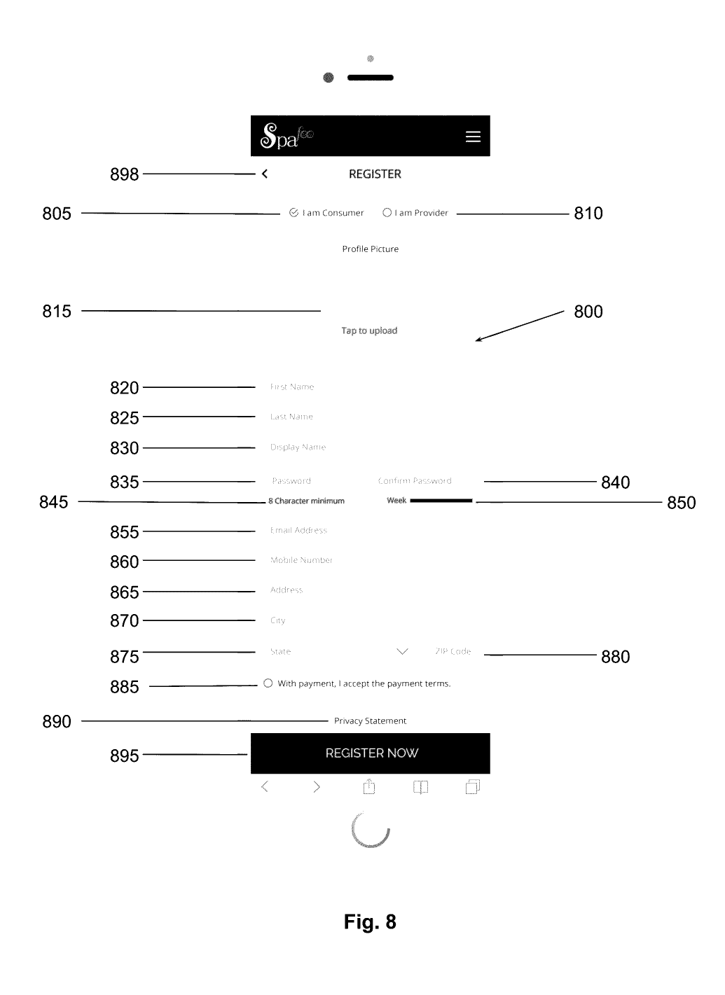

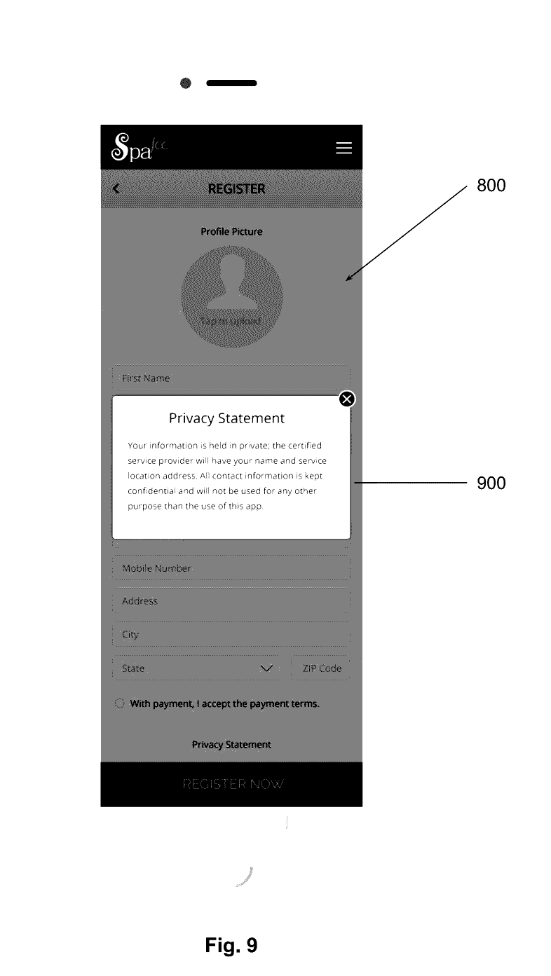

Consumers and providers may use the same screen to register with the matching system 100, or separate sign-in screens may be provided for either type of user. FIG. 8 illustrates an exemplary registration screen 800 that may be used by both consumers and providers to register with the system. A checkbox 805 (e.g. a checkbox labelled “I am a consumer”) allows a user to indicate that the user is a consumer. A checkbox 810 (e.g. a checkbox labelled “I am a provider”) allows a user to indicate that the user is a provider. A profile picture element 815 may be provided to display a user's photo. The user may upload a photo by tapping the profile picture element 815. A text box 820 allows the user to enter a first name. A text box 825 allows the user to enter a last name. A text box 830 allow the user to enter a display name. A text box 835 allows a user to enter a password, and text box 840 allows a user to confirm the password. A password criteria display element 845 may display the system's requirements for a password (e.g. “8 character minimum”), while a password strength element 850 may display the strength of the password entered by the user (e.g. “weak” or “strong”) Text boxes 855, 860, 865, and 870 allow a user to enter an email address, mobile number, address, and city, respectively. Dropdown 875 allows a user to enter a state. Text box 880 allows a user to enter a postal code. Checkbox 885 allows a user agree that the user accepts the system's payment terms each time the user makes a payment. The link 890 allows the user to read a privacy statement pertaining to the system by opening a privacy statement pop-up box 900 as depicted in FIG. 9. A “Register Now” button 895 allows the user to complete the registration process by directing the system to process the registration information entered by the user. A back arrow 898 allows the user to return to the previous screen.

Privacy Statement

FIG. 9 illustrates an exemplary privacy statement pop-up box 900 that may be provided to allow users to read the system's privacy statement. It may be displayed on top of the registration screen 800 or elsewhere.

Consumer Navigation

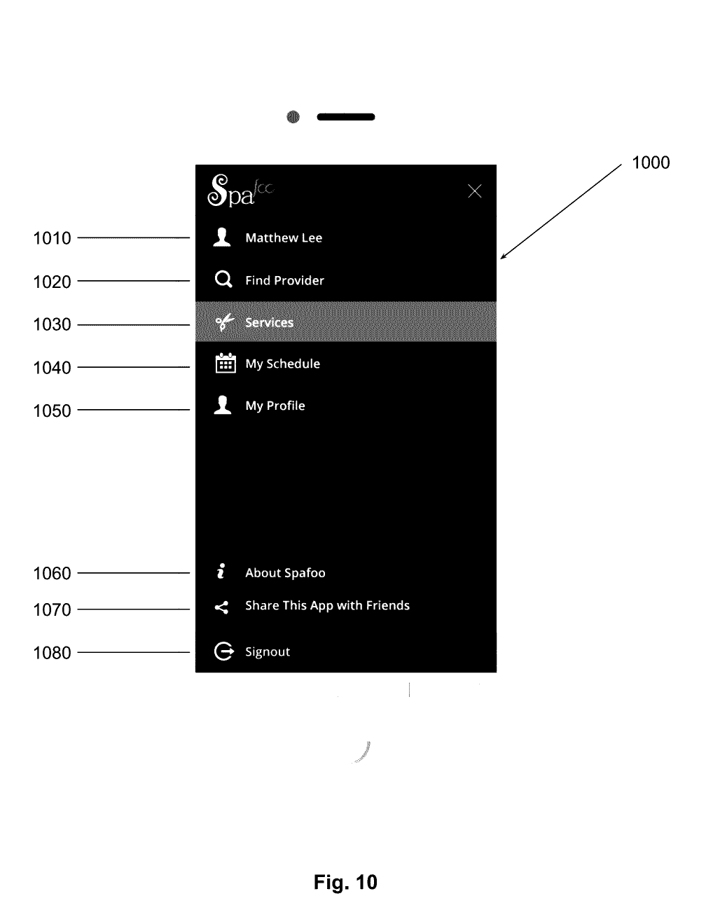

FIG. 10 illustrates an exemplary consumer navigation screen 1000 that allows a consumer to find providers, search for services, view scheduled appointments, and view the consumer's profile. A consumer identification box 1010 may be provided to display information about the consumer, including the consumer's name and photo. A “Find Provider” button 1020 allows a consumer to search for a service provider by opening a provider search screen 1100 (see FIG. 11). A “Services” button 1030 allows a consumer to search for services by opening a services search screen 1500 (see FIG. 15). A “My Schedule” button 1040 displays the consumer's scheduled appointments by opening consumer schedule screen 2100 (see FIG. 21). A “My Profile” button 1050 allows the consumer to view or edit the consumer's profile by opening consumer profiles screen 1400 (see FIG. 14). An system information button 1060 (e.g. “About Spafoo”) opens a screen displaying information about the system and/or information about the entity responsible for operating the system. A button 1070 allows the consumer to share the matching application 340 with others through social media applications, app platforms, and other means. A button 1080 allows the consumer to sign out of the matching application 340.

Searching for Providers

FIG. 11 illustrates an exemplary provider search screen 1100 that allows consumers to search for service providers. A service selection dropdown 1110 allows the consumer to select a service to be performed for the consumer. A map 1120 displays providers who are near the consumer's location and who provide the service selected in dropdown 1110. Providers are displayed as dots 1130a, 1130b, 1130c, and 1130d on the map 1120. A consumer may click on a particular dot to view information about the provider represented by the dot. The information presented may include the provider's name and the number of minutes the provider is from the consumer's location. The provider information may be presented in various ways, such as an information bubble 1140 associated with a dot and an information strip 1150 located outside the map area. An information bubble 1140 may include information such as the provider's name, the number of minutes the provider is from the consumer's location. An information bubble 1140 may also include an arrow 1160 that opens a provider profile screen 2000 (see FIG. 20) that provides additional information about the provider. An information strip 1150 may include information such as the provider's name, a photo of the provider, and a message from the provider. The consumer may select a button 1170 (e.g. “ASAP—I'm Ready Now!”) to indicate that the consumer wishes to schedule an appointment as soon as possible. The consumer may also select a button 1180 (“Schedule Appointment”) to open an appointment screen 1200 (see FIG. 12) that allows the consumer to schedule an appointment for a date and time in the future. A button 1190 allows the user to return to the previous screen.

Making an Appointment

FIG. 12 illustrates an exemplary appointment screen 1200 that allows a consumer to make an appointment with a provider. A location selector 1210 allows the consumer to select a location for the appointment. When the consumer taps the location selector 1210, the application opens an appointment location selection screen 1300 as illustrated in FIG. 13. A date selector 1220 allows a consumer to select a date for the appointment. A time selector 1230 allows a consumer to select a time for the appointment. A service selector 1240 allows the user to select one or more services from a list of services that the provider offers. A notes area 1250 allows a consumer to post optional comments for the provider. A “Continue” button 1260 directs the application to process the information the consumer has entered. A button 1270 allows the user to return to the previous screen.

Selecting an Appointment Location

FIG. 13 illustrates an exemplary appointment location selection popup 1300. A consumer may select from a list of three radio buttons. If the consumer selects the “My Current Location” radio button 1310, the system will schedule the appointment for the location that corresponds to the consumer's current GPS location. If the consumer selects the “My Profile Address” radio button 1320, the system will schedule the appointment for the location that corresponds to the location identified in the consumer's profile. See FIG. 14. If the consumer selects the “Custom Address” radio button 1330, the system will schedule the appointment for the location the user enters. The consumer may enter a custom address using an address text box 1340, a city text box 1350, a state dropdown list 1360, and a zip text box 1370. The consumer may save the selected appointment location by tapping a “Save” button 1380 and may close the appointment location selection popup by clicking the “X” close symbol 1390. Of course, many other methods of selecting an appointment location are possible (e.g. selecting a point or area on a map, entering a zip code, selecting a neighborhood, etc.)

Viewing a Consumer Profile

FIG. 14 illustrates an exemplary consumer profile display screen 1400 that allows a consumer to view the consumer's profile. An “Edit Your Profile” link 1405 opens an consumer profile edit screen that allows a consumer to edit his or her profile. A profile picture element 1410 may be provided to display a user's photo. The user may upload a photo by tapping the profile picture element 1410. A profile summary area 1415 displays high-level information about the consumer, such as the consumer's name, consumer's email address, and consumer's join date. A personal information area 1420 displays personal information about the consumer, such as the consumer's name, display name, password (redacted), and email address. A contact information area 1425 displays contact information about the consumer, such as the consumer's phone number, email address, and address. A payment method area 1430 displays the payment method selected by the consumer. An “Add a Credit Card” button 1435 allows the consumer to add a credit card as a payment method. A notification center 1440 displays notifications intended for the consumer. A notification icon 1445 indicates whether new notifications are waiting for the consumer. A back button 1450 allows the user to return to the previous screen.

FIGS. 15-18 illustrate an exemplary screens selecting hair care services. Many other selection techniques are possible (e.g. dropdown lists, radio buttons, etc.). Matching application 340 may match providers and consumers of all kinds of personal care services (e.g. massage, yoga, anti-aging treatments, etc.), and the hair care selection screens depicted in FIGS. 15-18 are presented merely as examples.

Selecting Whether the Consumer is a Woman, Man, or Child

To facilitate searching, services may be grouped together into categories based on demographic characteristics. For example, services may be grouped together based on whether the consumer is a woman, man, or child. FIG. 15 illustrates an exemplary service selection screen 1500 that allows a consumer to select whether the service will be performed for a woman, man, or child. A selection area 1510 allows the consumer to select services for women. A selection area 1520 allows the consumer to select services for men. A selection area 1530 allows the consumer to select services for children. A back button 1540 allows the user to return to the previous screen.

Selecting a Type of Service

FIG. 16 illustrates an exemplary service selection screen 1600 that appears after a consumer indicates that she is a woman. A selection area 1610 allows the consumer to select hair-related services. A selection area 1620 allows the consumer to select manicure and pedicure services. A selection area 1630 allows the consumer to select makeup services. A selection area 1650 allows the consumer to select massage services. A back button 1660 allows the user to return to the previous screen.

Selecting a Hair Type

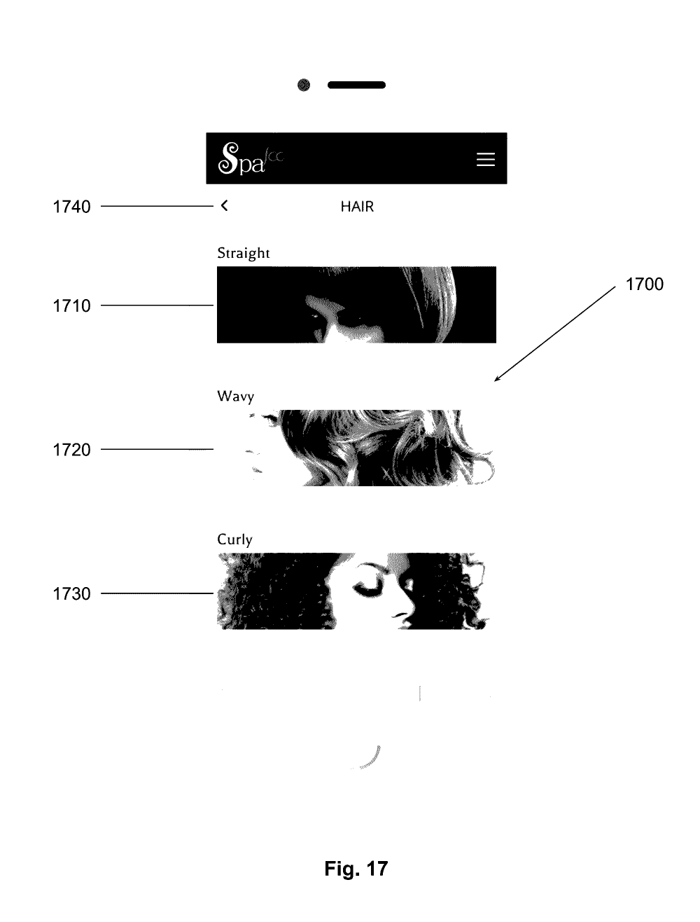

Hair stylists may specialize in different types of hair or may offer services for only one type of hair. FIG. 17 illustrates an exemplary hair type selection screen 1700 that appears after a consumer indicates that hair-related services are requested. A selection area 1710 allows the consumer to select services for straight hair. A selection area 1720 allows the consumer to select services for wavy hair. A selection area 1730 allows the consumer to select services for curly hair. A back button 1740 allows the user to return to the previous screen.

Selecting a Hair Service

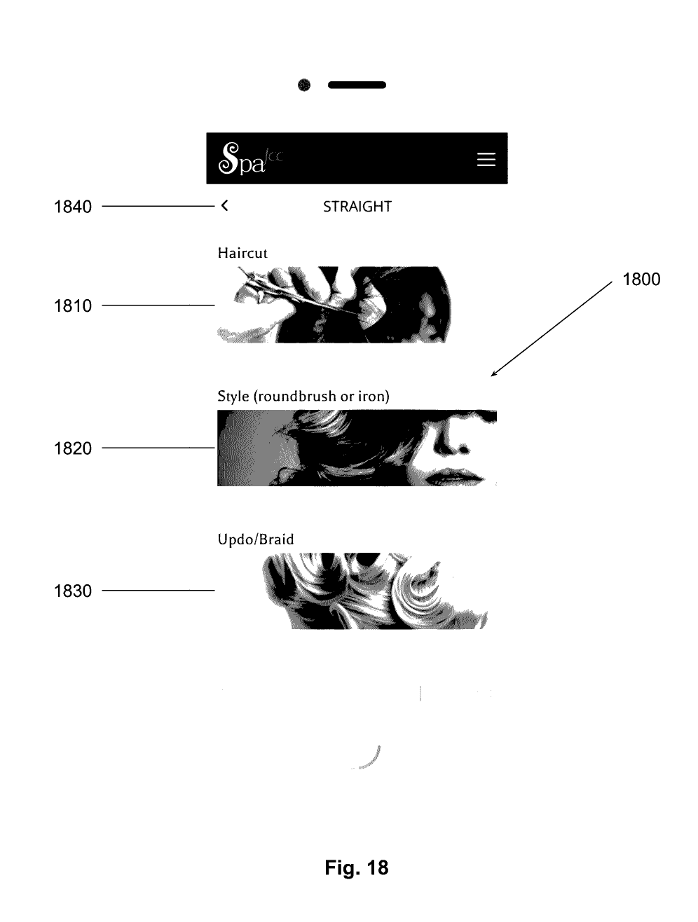

Various services may be offered for a particular hair type. For example, haircuts, styling, and updo's and braiding may be offered for straight hair. FIG. 18 illustrates an exemplary hair service selection screen 1800 that appears after a consumer indicates that services are requested for straight hair. A selection area 1810 allows the consumer to select haircut services. A selection area 1820 allows the consumer to select style services (e.g. roundbrush or iron). A selection area 1830 allows the consumer to select updo or braid services. A back button 1840 allows the user to return to the previous screen.

Viewing Provider Results

After the consumer selects a requested service, the application may display a list of nearby providers who provide the selected service. FIG. 19 illustrates an exemplary provider selection screen 1900 that allows a user to select a particular provider from a list of relevant providers. For each provider, the system may display a provider photo 1910 (e.g. a provider's headshot or other representative image), a provider name 1920, provider message 1930, a provider rating 1940, and a provider distance element 1950.

Provider Portfolio

A consumer may learn details about a particular provider by viewing the provider's portfolio. FIG. 20 illustrates an exemplary provider portfolio screen 2000 that displays the provider's photo 2010, the provider's distance from the consumer 2020, the provider's name 2030, the provider's message 2040, and the average rating 2050 the provider has received from consumers. The portfolio screen also displays the services offered by the provider 2060 (e.g. “men, women, kids, cuts, styles (blowout and iron), updo”), the provider's bio 2070, and the provider's work samples 2080. A consumer may schedule an appointment immediately by selecting button 2090 (“ASAP—I'm Ready Now!”) or may schedule an appointment for a future time and date by selecting button 2095 (“Schedule Appointment”). A consumer may also schedule an appointment by selecting button 2098 (“Make Appointment”).

Consumer Schedule

A consumer may view upcoming and past appointments via a client schedule screen. FIG. 21 illustrates an exemplary client schedule screen 2100 that displays upcoming appointments under an upcoming appointments header 2110 (“My Schedule”) and past appointments under a past appointments header 2120 (“Accomplished”). Under the upcoming appointment header 2110, the application displays appointment-related information such as an appointment date and time formatted as an image 2130 and a text element 2140, an appointment location 2150, an appointment provider 2160, and services to be provided during the appointment 2170. Under the past appointments header, the application displays information similar to that displayed for upcoming appointments but also provides a rating box 2180.

Consumer Schedule Details

Via a consumer schedule detail screen, a consumer may view additional details about an appointment and edit or cancel an appointment. FIG. 22 illustrates an exemplary consumer schedule detail screen 2200, which displays a provider photo 2210, an appointment status indicator 2220, an appointment date 2230, an appointment time 2240, an appointment location 2250, an appointment provider 2260, and services to be provided during the appointment 2270. The screen also provides a cancel button 2280 that allows a consumer to cancel an appointment and an edit button 2290 that opens an appointment screen 1200 (FIG. 12) to allow a consumer to change appointment details, such as the date, time, or services to be rendered.

Rating a Provider

FIG. 23 illustrates an exemplary rating screen 2300 that a consumer may use to rate a provider. The screen displays the provider's name 2310 and the provider's photo 2320 and provides an overall star rating element 2330, a work quality rating element 2340, a time punctuality rating element 2350, and a comments text box 2360. A consumer may select how the consumer's name will be displayed next to the consumer's rating by selecting a format from a name display format dropdown list 2370. The screen may also include a checkbox 2380 the consumer may select in order to confirm that the information in the review is true and accurate. A consumer may select a Submit button 2390 in order submit his or her review.

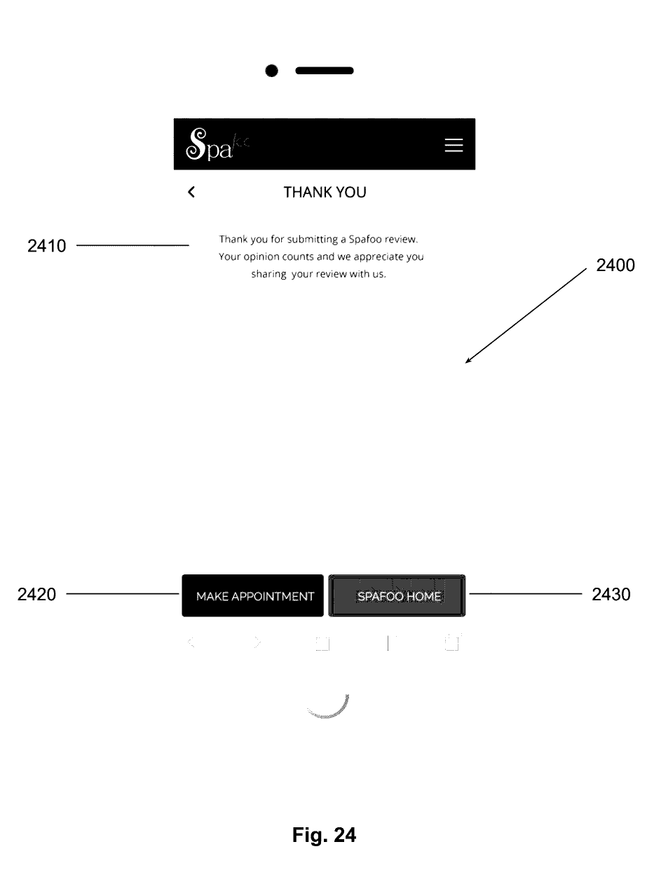

FIG. 24 illustrates an exemplary thank you screen 2400 that displays a thank you message 2410 after a consumer rates a provider. The bottom of the screen provides a make appointment button 2420 and a home button 2430.

Viewing Order Summary

FIG. 25 illustrates an exemplary order summary screen 2500 that displays information about the services a consumer has ordered. The screen displays an appointment date 2505, an appointment time 2510, an appointment location 2515, and an appointment provider 2505. Under a services header 2525, the application displays services 2530a, 2530b, and 2530c (e.g. “updo”, “iron”, and “haircut”), number of services 2535, cost for services 2540, subtotal 2545, tax 2550, and total 2555. A continuation button 2560 allows a user to approve the charges and proceed to a payment popup screen 2600.

FIG. 26 illustrates an exemplary payment confirmation popup screen 2600 that displays a total cost 2610, a cancel button 2620, and an OK button 2630. A consumer may select the cancel button 2620 to cancel payment or may select the OK button 2630 to confirm the appointment for the services listed on screen 2500.

FIG. 27 illustrates an exemplary appointment confirmation popup screen 2700 that displays a confirmation message 2710 (“Your Appointment has been confirmed!”) and an OK button 2720 that allows a consumer to dismiss the popup screen.

Payment Method Screen

FIG. 28 illustrates an exemplary payment method selection screen 2800. The screen depicted in FIG. 28 provides a credit card option 2810, but one or more other types of payment methods may be provided, such as PayPal, drafting from a checking account, and gift certificates.

Credit Card Information Screen

FIG. 29 illustrates an exemplary payment information screen 2900 that allows a consumer to enter credit card information, such as the consumer's name 2910, a credit card number 2920, a credit card type 2930 (e.g. Visa, American Express, MasterCard, and Discover), an expiration month 2940, an expiration year 2950, and a security code (CVV) 2960. The screen also provides a checkbox 2970 indicating that the consumer wishes the application to remember the consumer's credit card information and a checkbox 2980 that allows the user to accept the payment terms. A consumer may select a “Pay Now” button 2990 to initiate payment. FIG. 30 illustrates an exemplary payment terms popup screen 3000 that informs the consumer about payment terms, such cancellation fees. The pop-up screen may be dismissed by selecting the X button 3010.

Provider Navigation

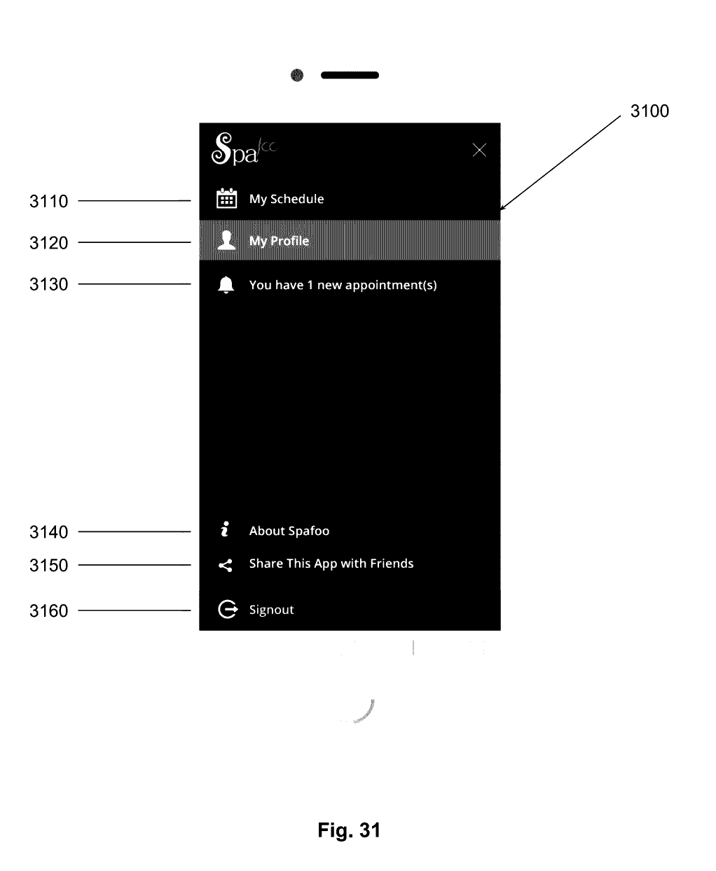

FIG. 31 illustrates an exemplary provider navigation screen 3100 that allows a provider to view scheduled appointments, view the provider's profile, and view new appointments. A button 3110 (“My Schedule”) allows a provider to view scheduled appointments by opening provider appointment screen 3300 (FIG. 33). A button 3120 (“My Profile”) allows a provider to view the provider's profile by opening provider profile screen 3900 (FIG. 39). A button 3130 displays the provider's new appointments. A button 3140 (e.g. “About Spafoo”) opens a screen displaying information about the system and/or information about the entity responsible for operating the system. A button 3150 allows the provider to share the matching application 340 with the provider's friends. A button 3160 allows the provider to sign out of the application.

Provider Schedule Navigation Screen

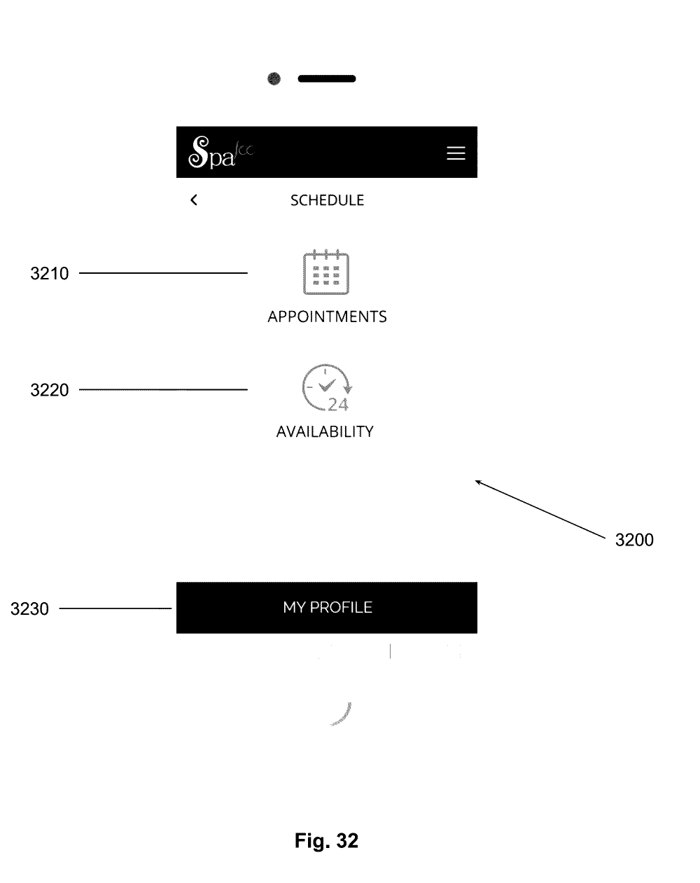

FIG. 32 illustrates an exemplary provider schedule screen 3200 that allows a provider to navigate to additional appointment-related screens. A consumer may navigate to an provider appointments screen 3300 (FIG. 33) by selecting an “Appointments” button 3210. A consumer may navigate to a provider availability screen 3700 by selecting an “Availability” button 3220. A consumer may navigate to a Provider Profile screen 3900 (FIG. 39) by selecting a “My Profile” button 3230.

Provider Schedule Screen

A provider may view upcoming and past appointments via a provider schedule screen. FIG. 33 illustrates an exemplary provider schedule screen 3300 that displays upcoming appointments under an upcoming appointments header 3310 (“My Appointments”) and past appointments under a past appointments header 3320 (“Accomplished”). Under the upcoming appointment header 3310, the application displays appointment-related information such as an appointment date and time formatted as an image 3330 and a text element 3340, an appointment location 3350, an appointment provider 3360, and services to be provided during the appointment 3370. Under the past appointments header, the application displays information similar to that displayed for upcoming appointments but also provides a rating box 3380.

Provider Schedule Details

Via a provider schedule detail screen, a provider may view additional details about an appointment, edit or cancel an appointment, and indicate that he or she has arrived at an appointment location. FIG. 34 illustrates an exemplary provider schedule details screen 3400, which displays a map 3410, a dot 3420 on the map indicating the appointment location, a bubble 3430 associated with the dot that contains the consumer's photo and name, an appointment status indicator 3440 (e.g. “Not Complete”), an appointment date 3450, an appointment time 3460, the consumer's name 3470, and services to be performed 3480. A provider may indicate that he or she has arrived at an appointment location by selecting an “I've Arrived” button 3490.

Appointment Completion Screen

FIG. 35 illustrates an exemplary appointment completion screen 3500. A provider may upload photos related to an appointment via a photo uploader 3510. A provider may post comments relating to an appointment via a comments text box 3520 and may rate a consumer using a rating element 3530. The provider may indicate that an appointment has been completed by selecting an “Appointment Completed” button 3540.

Rating a Consumer

FIG. 36 illustrates an exemplary rating screen 3600 that a provider may use to rate a consumer. The screen displays the consumer's name 3610 and the consumer's photo 3620 and provides an overall star rating element 3630, a “What I like” text box 3640, a “What I dislike” text box 3650. The screen also provides a time punctuality rating element 3660, a communication rating element 3670, a cooperation rating element 3680, and an attitude rating element 3690. A consumer may select a Submit button 3695 in order submit his or her review.

Provider Availability Screen

FIG. 37 illustrates an exemplary provider availability screen 3700 that allows a provider to enter dates and times that the provider is available to perform services. A calendar 3710 indicates days that a provider is available by highlighting those days with a highlight color 3720. The month name 3730 is displayed at the top of the calendar. A provider may navigate to different months using a back button 3740 and forward button 3750. Specific availability information about each day on the calendar may be viewed by tapping a particular day on the calendar. In this example, availability information is displayed below the calendar and includes information such as the date 3760, start time 3770, and end time 3780. A provider may edit availability information using an edit button 3790 (e.g. a button bearing a pencil and paper symbol) and may delete availability information using a delete button 3795 (e.g. a button bearing a trash can symbol).

FIG. 38 illustrates an exemplary time selector popup screen 3800 for entering start and end times for provider availability. A provider may enter a start time hour 3810, a start time minute 3820, a start time AM/PM indication 3830, an end time hour 3840, an end time minute 3850, and an end time AM/PM indication 3860. A provider may submit the time information using a “Done” button 3870 and may dismiss the popup window using an “X” button 3880.

Provider Profile Display Screen

FIG. 39 illustrates an exemplary provider profile display screen 3900 that allows a provider to view the provider's personal information, contact information, bio, and work samples. The screen displays the provider's photo 3905, the provider's name 3910, the provider's email address 3915, the date the provider joined the system 3920. Under a “Personal Information” header 3925, the screen displays the provider's full name 3930, the provider's display name 3935, a redacted password 3940, and a tag line 3945 (e.g. “Have a great hair day!”). Under a “Contact Information” header 3950, the screen displays the provider's phone number 3955, the provider's email address 3960, and the provider's address 3965. Under a “Bio” header 3970, the screen displays the provider's bio 3975. Under a “Work Samples” header 3980, the screen displays photos relating to the provider's services. An “Edit Your Profile” button 3990 allows the provider to navigate to an information input screen 4000, illustrated by FIG. 40.

Provider Profile Edit Screen

FIG. 40 illustrates an exemplary provider profile edit screen 4000 that allows a provider to edit his or her profile information. The provider's display name 4005 is displayed along with the provider's photo 4010. A provider may select a “Tap to Update” link 4015 to update the provider's profile photo 4010. A provider may enter text in a first name text box 4020, a last name text box 4025, a phone number text box 4030, and an email address text box 4035. A provider may also update the provider's tag line and bio via a tag line text box 4040 and a bio text box 4045. A provider may update work samples by selecting a work sample image 4050. Selecting an image may then open a photo uploader. A provider may submit changes by selecting an “Update” button 4055.

We claim:

1. A computer-implemented method for matching providers and consumers of personal care services comprising:
receiving from a consumer a location associated with the consumer;
transmitting to the consumer an identification of a personal care service provider located within a geographical area associated with the consumer's location;
transmitting an identification of a personal care service offered by the personal care service provider;
receiving from the consumer a request for the personal care service offered by the personal care service provider;
generating an appointment for the consumer and the personal care service provider based on the consumer's request;
transmitting appointment-related information to the consumer; and
transmitting appointment-related information to the personal care service provider.

2. The method of claim 1, further comprising:
receiving a payment for the personal care service requested by the consumer.

3. The method of claim 2, wherein the payment is based on a pre-determined fee associated with a category of personal care services.

4. A computer-implemented method for matching providers and consumers of personal care services comprising:
receiving from a consumer a location associated with the consumer;
receiving from the consumer an identification of a personal care service;
transmitting to the consumer an identification of a personal care service provider who is located within a geographical area associated with the consumer's location and who offers the personal care service identified by the consumer;
receiving from the consumer a request for the personal care service provider to perform the personal care service identified by the consumer;
generating an appointment for the consumer and the personal care service provider based on the consumer's request;
transmitting appointment-related information to the consumer; and
transmitting appointment-related information to the personal care service provider.

5. The method of claim 4, further comprising:
receiving a payment for the personal care service requested by the consumer.

6. The method of claim 5, wherein the payment is based on a pre-determined fee associated with a category of personal care services.

7. A computer system for matching providers and consumers of personal care services, the computer system comprising a processor and a computer-readable medium, the computer-readable medium including computer program code for:
receiving from a consumer a location associated with the consumer;
transmitting to the consumer an identification of a personal care service provider located within a geographical area associated with the consumer's location;
transmitting an identification of a personal care service offered by the personal care service provider;
receiving from the consumer a request for the personal care service offered by the personal care service provider;
generating an appointment for the consumer and the personal care service provider based on the consumer's request;
transmitting appointment-related information to the consumer; and
transmitting appointment-related information to the personal care service provider.

8. The computer system of claim 7, wherein the computer-readable medium further includes computer program code for:
receiving a payment for the personal care service requested by the consumer.

9. The computer system of claim 8, wherein the payment is based on a pre-determined fee associated with a category of personal care services.

10. A computer-implemented method for matching providers and consumers of personal care services comprising:
receiving from a consumer a location associated with the consumer;
receiving from the consumer an identification of a personal care service;
transmitting to the consumer an identification of a personal care service provider who is located within a geographical area associated with the consumer's location and who offers the personal care service identified by the consumer;
receiving from the consumer a request for the personal care service provider to perform the personal care service identified by the consumer;
generating an appointment for the consumer and the personal care service provider based on the consumer's request;
transmitting appointment-related information to the consumer; and
transmitting appointment-related information to the personal care service provider.

11. The computer system of claim 10, wherein the computer-readable medium further includes computer program code for:
receiving a payment for the personal care service requested by the consumer.

12. The computer system of claim 11, wherein the payment is based on a pre-determined fee associated with a category of personal care services.
